(19) United States
(12) Patent Application Publication
(10) Pub. No.: US 2007/0020596 A1
(43) Pub. Date: Jan. 25, 2007

(54) Behavior Shaping System and Kits

(76) Inventor: Kristen L. Thurman, Spring Hill, TN (US)

Correspondence Address: W. EDWARD RAMAGE, COMMERCE CENTER SUITE 1000, 211 COMMERCE ST, NASHVILLE, TN, 37201, US

(21) Appl. No.: 11/534,638

(22) Filed: Sep. 23, 2006

Related U.S. Application Data
(63) Continuation-in-part of application No. 10/236,902, filed on Sep. 9, 2002.
(63) Continuation-in-part of application No. 11/279,466, filed on Apr. 12, 2006.
Application No. 11/279,466 is a continuation-in-part of application No. 10/236,902, filed on Sep. 9, 2002.

(51) Int. Cl. G09B 19/00

(52) U.S. Cl. 434/238

(57) ABSTRACT

A system for modifying and shaping behavior. The system comprises a number of components, which may be used individually or in combination with other components. A variety of kits comprising various components can be formed. Components include a progress pyramid chart to reward and reinforce positive and desired behaviors, a graduated restrictions chart and work-before-play chart to discourage undesirable behaviors, a daily responsibilities or daily routine chart may be used to clarify and strengthen daily family routines, a point-based or token-based system may be used to reward children for appropriate actions or behavior, a tether or leash used to teach self restraint, a series of school success charts or plans used to monitor school work (on a daily, weekly, and monthly basis), a gratitude jar, a series of life skills charts (including a learning chart, decision-making chart, anger management chart, communication chart, problem-solving chart, and goal-setting chart), a mission statement for the family, a vision or manifestation chart for use by a caregiver, and a family coat-of-arms. These charts may include color-coded clips that correspond to color-coded timers, which may be used to teach the concept of graduated restrictions. The timers are used to define break or “time out” periods, and the colors may indicate the severity of the restriction. The above components and kits can be presented and used in a variety of formats: a clipboard, poster, magnetic material, board, computer program, television, hand-held computer or laptop, mobile phone, personal digital assistant, MP3 or music device, iPod, or similar electronic device.

This application is a continuation-in-part of U.S. patent application Ser. No. 10/236,902, filed Sep. 9, 2002, by Kristen Thurman, and a continuation-in-part of U.S. patent application Ser. No. 11/279,466, filed Apr. 26, 2006, by Kristen Thurman, and is entitled in whole or in part to those filing dates for priority. The specification and drawings of U.S. patent application Ser. Nos. 10/236,902 and 11/279,466 are incorporated herein in their entirety by reference.

### BACKGROUND OF THE INVENTION

The present invention relates to a behavior shaping system, and related kits and methods, and particularly to a behavior shaping system, and kits and methods, suitable for a caregiver to utilize when teaching or disciplining children of any age.

In disciplining young children, it is generally necessary to communicate as clearly as possible to a child what kinds of behavior are deemed to be acceptable or desirable as well as unacceptable or undesirable. Properly defining behavior and responding quickly are important in communicating to a child the caregiver's expectations. For example, once a child is given warning that a certain behavior is unacceptable or undesirable, providing feedback in response to the unacceptable or undesirable behavior reaffirms the inappropriateness of the child's action. It is considered desirable that feedback be provided as quickly as possible following the display of a behavior, so that the child will be able quickly and clearly to associate the feedback with the behavior for which it was given. It is also considered desirable to provide ongoing feedback, so that a child can know with certainty that a given behavior will result in a particular, specific, and consistent response.

Traditional forms of discipline utilized by caregivers, such as parents, babysitters, or guardians, often include spanking and yelling. These forms of discipline, while relaying to the child that the misbehavior is unacceptable or undesirable, tend to have many negative side effects. Spanking and yelling generally cause the child to fear the caregiver. This type of discipline also demoralizes the child, promotes poor self-esteem, and leaves the child feeling powerless. The caregiver teaches by example that yelling at another or hitting another when angry or frustrated is acceptable or desirable behavior.

Other methods of disciplining children which do not immediately address misbehavior make it more difficult for the child to associate a negative result with a given misbehavior. For example, ignoring misbehavior while rewarding good or desirable behavior seems to relay that misbehavior is tolerable, rather than undesirable. Thus, a discipline system which quickly and clearly communicates that rewards and restrictions are directly linked to a given behavior is desirable.

U.S. Pat. No. 5,697,790, issued Dec. 16, 1997 to A. Garland, discloses a method for a caregiver to teach or discipline a child which involves the caregiver selecting a plurality of tokens in response to misbehavior of the child and instructing the child of a suitable token phrase relating to the misbehavior. The child places at least one of the tokens into a first portable container and repeats the token phrase. The child repeats the act of placing the tokens and repeating the token phrase a plurality of times. Other patents relating to behavior monitoring and modification include U.S. Pat. No. 2,414,614, issued Jan. 11, 1945 to E. Shurick (device carrying names of children and a corresponding daily actuatable indicator so child may keep a record of conduct during the course of a week, the arrangement being such that if child is deserving, the device will discharge a prize); U.S. Pat. No. 4,741,701, issued May 3, 1988 to S. Kossor (behavior monitoring and status reporting device has indicator to show the current status of the child's behavior as the child completes each of a series of objectives); U.S. Pat. No. 5,387,107, issued Feb. 7, 1995 to L. Gunter (story book for teaching desired behavioral patterns); U.S. Pat. No. 5,470,235, issued Nov. 28, 1995 to S. Papaleo (child behavior improvement system utilizes support member with plurality of receptacles for receiving indicia of reward); U.S. Pat. No. 5,573,404, issued Nov. 12, 1996 to W. Stawski (behavior modification device comprising implement depicting various activities separated into columns, with assigned monetary value); U.S. Pat. No. 5,573,405, issued Nov. 12, 1996 to S. Evans (behavior training and modification device includes board having plurality of pegs and indicator plates); U.S. Pat. No. 5,954,512, issued Apr. 17, 1998 to D. Fruge (behavior tracking board for monitoring behavior for a certain period and determining rewards and punishment accordingly); Japanese Patent No. 2000024169 (intellectual training game for infants); U.S. Pat. No. 5,725,382 issued Mar. 10, 1998 to J. Walter (self-contained, interactive toilet training kit for children and caregivers); U.S. Pat. No. 6,250,929 B1 (methods for improving effectiveness of toilet training).

Accordingly, what is needed is a system and method for teaching and reinforcing appropriate behavior of children while discouraging inappropriate behavior in a variety of contexts.

### SUMMARY OF THE INVENTION

The present invention provides a system and method for teaching and reinforcing desired behavior in children, and for discouraging undesirable behaviors. In one exemplary embodiment, a progress pyramid chart may be used to reward and reinforce positive and desired behaviors.

In another exemplary embodiment, a graduated restrictions chart and work before play chart may be used, separately or together, to discourage undesirable behaviors. These charts may include color-coded clips that correspond to color-coded timers. The timers are used to define break or “time out” periods, and the colors may indicate the severity of the restriction.

In yet another exemplary embodiment, a daily responsibilities or daily routine chart may be used to clarify and strengthen daily family routines. Additionally, a point-based or token-based system may be used to reward children for appropriate actions or behavior. Accumulated points may be exchanged for a reward.

In yet another exemplary embodiment, a tether or leash may be used with young children to teach self-restraint and self-containment.

In yet another exemplary embodiment, a series of school success charts or plans may be used to monitor school work. Monitoring may be done on a daily, weekly, and monthly basis. Successful work is tallied and the child may be rewarded or incur adverse consequences as a result.

In yet another exemplary embodiment, a gratitude jar may be used by the family as a means of commemorating things for which they are grateful. A family member writes down the indication for which they are thankful, and places it in a container. Periodically, the accumulated slips of paper may be disposed of in a ceremonial way.

In yet another exemplary embodiment, one or more life skills charts may be used. These include a learning chart, decision-making chart, anger management chart, communication chart, problem-solving chart, and goal-setting chart. These charts use graphical means to help the user deal with the issues indicated.

In another exemplary embodiment, one or more family foundational elements may be used. These include a family intention chart comprising a mission statement for the family, a vision or manifestation chart for use by a caregiver, and a family coat-of-arms.

In another exemplary embodiment, kits with various components may be assembled. One example is a young child behavior shaping kit and process for a caregiver to teach discipline to a child while minimizing the tendency for miscommunication, and which prevents tension between caregiver and child. In one form of the invention, the kit includes at least one time-out defining device, at least one timer, a plurality of stickers having prohibitory indicia marked thereon, training devices for a caregiver, a plurality of stop signs, and craft tools. The caregiver affixes stickers having prohibitory indicia marked thereon to items in the house with which the child should not come into contact. When a child does come into contact with these items, the child is immediately placed in a time-out area which is defined by a time-out defining device. A time-out defining device serves to create a time-out area.

In another form of the kit, the kit additionally comprises a contractual instrument which establishes activities and goals agreed upon by the child and the caregiver and consequences for performing or failing to perform a particular activity or achieving a particular goal. The caregiver and the child will utilize the craft tools to create symbols to represent goals and activities agreed upon by both the caregiver and the child, and affix these symbols to various objects in the house as helpful reminders. When a child misbehaves, the child may be placed in a time-out area and/or elect to suffer one of the consequences agreed upon in the contractual instrument.

Various other embodiments of kits include kits for pre-school age and school age children, including various combinations of the components described herein.

The above components and kits can be presented and used in a variety of formats: a clipboard, poster, magnetic material, board, computer program, television, hand-held computer or laptop, mobile phone, personal digital assistant, MP3 or music device, iPod, or similar electronic device.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIGS. 1A-1G is a top view of several exemplary embodiments of a progress pyramid chart.

FIG. 2 is a top view of another embodiment of a progress pyramid chart.

FIG. 3 is a top view of an exemplary embodiment of a graduated restrictions chart.

FIG. 4 is a top view of an exemplary embodiment of a work-before-play chart.

FIG. 5 is a top view of a daily responsibilities or daily routine chart.

FIG. 6 is a perspective view of a leash or tether.

FIG. 7 is a view of sand timers.

FIG. 8 is a view of a token system.

FIG. 9 is a view of another embodiment of a token system

FIG. 10 is a perspective view of two embodiments of a gratitude jar.

FIG. 11 is a top view of a daily school success plan.

FIG. 12 is a top view of a weekly school success plan.

FIG. 13 is a top view of a monthly school success plan.

FIG. 14 is a top view of a learning chart.

FIG. 15 is a top view of a decision making chart.

FIG. 16 is a top view of an anger management chart.

FIG. 17 is a top view of a communication chart.

FIG. 18 is a top view of a problem solving chart.

FIG. 19 is a top view of a goal setting chart.

FIG. 20 is a top view of a family intentions chart.

FIG. 21 is a view of a family coat-of-arms.

FIG. 22 is a view of a vision or manifestation chart.

FIG. 23 is a perspective view of a progress pyramid chart displayed on a personal computer.

FIG. 24 is a perspective view of a progress pyramid chart displayed on a cell phone or PDA.

FIG. 25 is a perspective view of a progress pyramid chart displayed on an iPod device.

FIG. 26 is a top perspective view of a toddler training kit according to one embodiment of the present invention.

FIG. 27 is a plan view of a room in which a child is confined in a time-out area.

FIG. 28 is a top perspective view of the components of a toddler teaching kit in accordance with one embodiment of the present invention.

FIG. 29 is a top perspective view of the component of a pre-school teaching kit in accordance with one embodiment of the present invention.

FIG. 30 is a top perspective view of the component of a school-age teaching kit in accordance with one embodiment of the present invention.

FIG. 31 is a top view of another embodiment of a progress pyramid chart with progress points.

FIG. 32 is a top view of another embodiment of a progress pyramid chart with progress points.

FIG. 33 is a top view of another embodiment of a progress pyramid chart with progress points.

FIG. 34 is a front view of a travel wallet for use with a progress pyramid chart.

FIG. 35 is a front view of another embodiment of a travel wallet for use with a progress pyramid chart.

FIG. 36 is a top view of a guideline chart in accordance with one embodiment of the present invention.

Similar reference characters denote corresponding features consistently throughout the attached drawings.

### DETAILED DESCRIPTION OF THE EXEMPLARY EMBODIMENTS

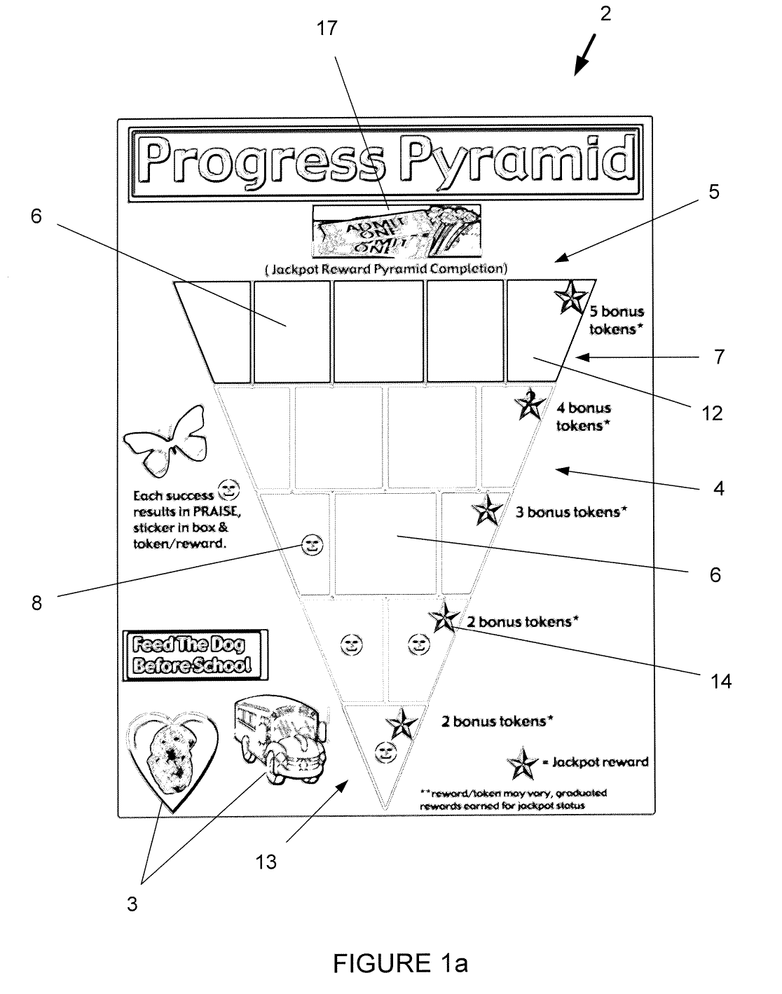

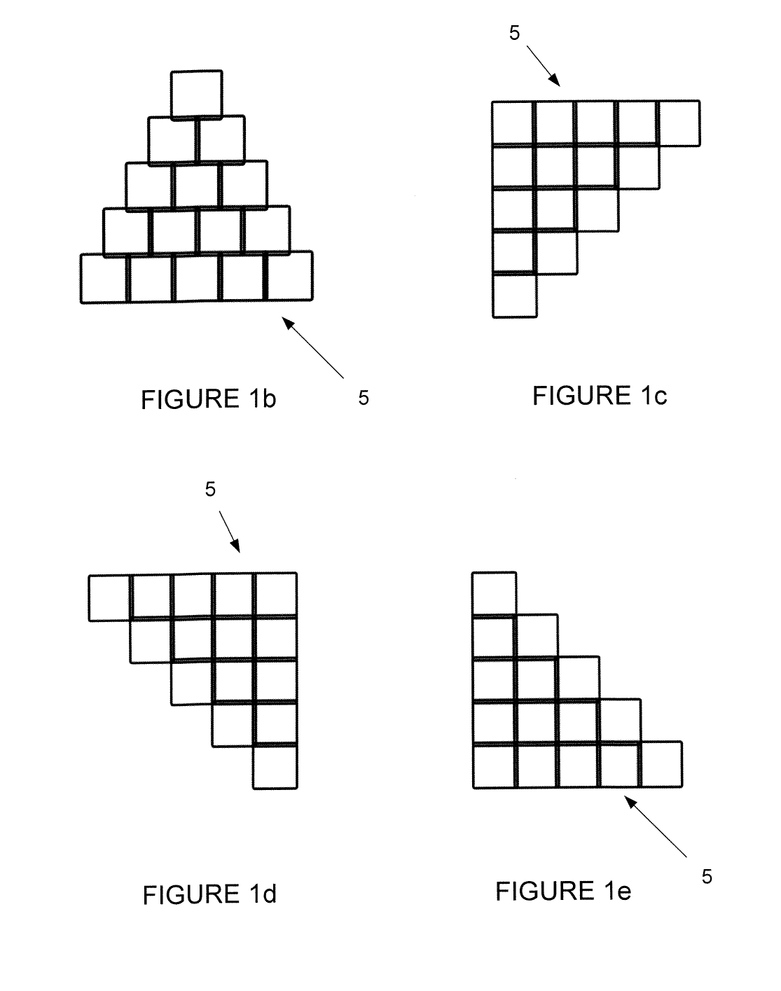

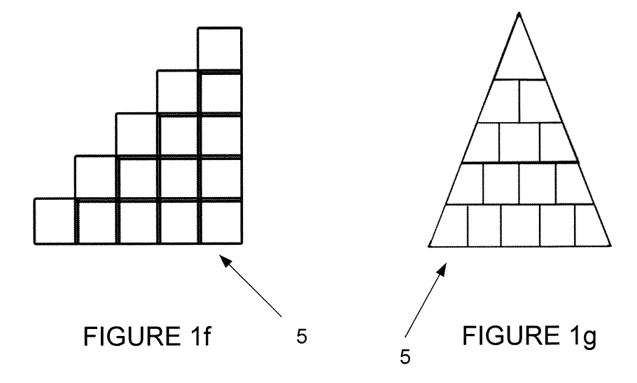

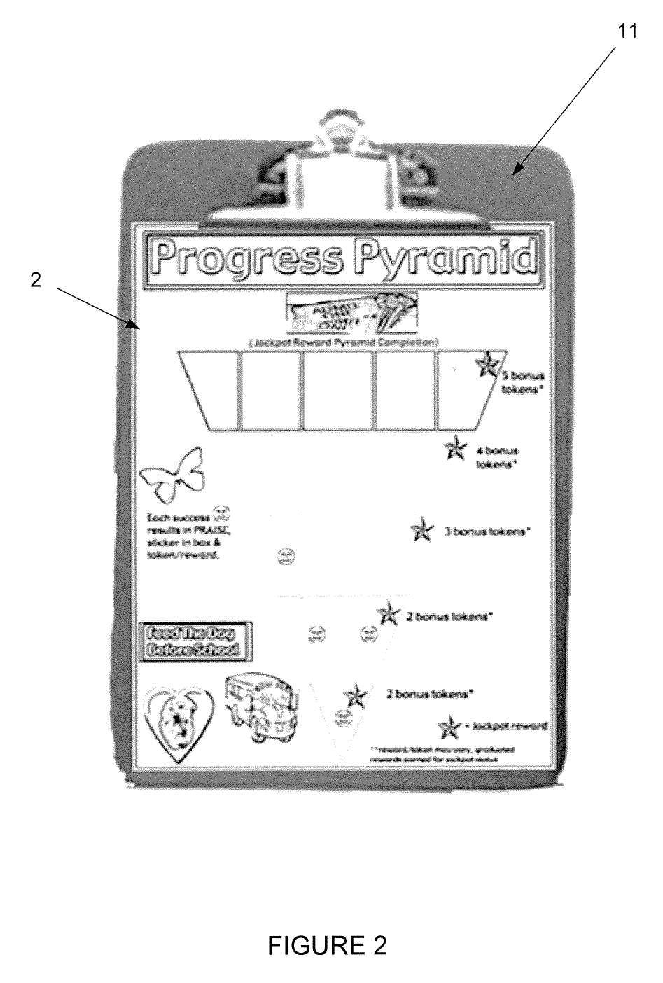

Referring now to the numerous figures, wherein like references identify like elements of the invention, FIG. 1A shows a component of a behavior shaping system comprising a progress pyramid chart 2. A triangular or pyramidal shape 4 may be located approximately in the center of the chart, and has a number of individually defined spaces 6 in which to place stickers or markers 8 or similar indicia. As seen in FIGS. 1A-1F, the base 5 of the triangle or pyramid 4 may be located at the bottom of the chart, or at the top (i.e., the triangle or pyramid is inverted), and the triangular shape may be aligned in a number of ways, including the center, the right, or the left. The pyramid 4 may comprise multiple layers 7 of blocks, shapes, or squares, each layer stacked on top of the previous layer as shown in FIGS. 1 and 2. The blocks, shapes, or squares may each be the same size, or variable in outline and size, as shown in FIGS. 1a-f. In an alternative embodiment, as seen in FIG. 1g, the pyramid may be a simple triangle with internal horizontal and vertical lines dividing the pyramid or triangle into layers and spaces.

The chart 2 may be made of any conventional material, such as paper, plastic, or cardboard. The material may be magnetic. In one exemplary embodiment, as seen in FIG. 2, the chart 2 may be on a clipboard 11. In another exemplary embodiment, the surface of the chart is a material that allows stickers or markers 8 to be placed on the chart and removed, repeatedly. Alternatively, the chart may be composed of a material suitable for writing and erasure, such as with dry-erase pens. In yet another embodiment, the chart can be in electronic form, and displayed on a personal digital assistant, iPod, cell phone, personal computer, or similar device.

In one exemplary embodiment, the space or block on one end of each row or layer is marked in some way to designate its significance as an end-space 12. This mark can be a star 14 inside the block, as shown in FIG. 1A. Alternative means can be used, such as outlining the block in a particular manner, or giving it a distinctive color. In a particular embodiment, as seen in FIG. 1A, the bottom or starting layer 13 has only one block, and this block also serves as the end-space.

In an exemplary embodiment, the progress pyramid chart 2 is used as a tool for teaching and rewarding new skills to a child. The chart 2 is marked with a word, phrase, picture, or symbol, or a combination of these elements 3, that represent the skill to be focused on. For example, a moon can be placed on the chart to symbolize cooperating at bed time, or a book to symbolize completing homework before dinner. Every time the child accomplishes the task or skill in question, the caregiver may celebrate with the child or offer the child a suitable reward or treat or reinforcer, and a sticker or marker 8 is placed in the appropriate block in sequence to recognize the accomplishment. In one embodiment, the task or skill in question may comprise the completion of multiple steps or requirements, such as using the potty, flushing, and washing their hands. Corresponding stickers or markers may be used for each step or requirement. Using the chart shown in FIG. 1A, the sequence would begin with the bottommost block, and work up from left to right. Every time a sticker or marker is placed in an end-space (e.g., a block with a star), the child obtains a significant reward (such as, but not limited to, spending extra quality time with the caregiver celebrating in a special way, drawing from a surprise jar, gaining access to a special toy, throwing a party, or preparing a special meal).

It should be noted that the first time the child accomplishes the task or skill, a sticker or marker is placed in an end-space to reinforce the behavior. Subsequently, the number of successes increases before an end-space is reached, with its concomitant reward. When the chart 2 is full of stickers, a “jackpot reward” 17 for pyramid completion may be awarded, the skill being taught can be raised to the level of an expectation, and the criteria for a reward can be raised accordingly. In one embodiment, a representative symbol can be added to the chart 2 accordingly. In another embodiment, mastered skills can be randomly rewarded with decreasing frequency over time. The chart 2 can then be used with a new picture or symbol for a new skill to be taught, or to reward higher levels of performance.

In another exemplary embodiment, a signal may be used each time the child accomplishes the task on the progress pyramid chart 2. The signal could be an audible device, light, word, hand signal, or the like. Such a signal may serve as a reinforcement mechanism to further facilitate learning the desired behavior.

In yet another exemplary embodiment, the spaces in each row may be colored. For example, a color progression from pewter to platinum may be used to indicate progress being made.

In another exemplary embodiment, the progress pyramid chart 2 may be used as a tool for eliminating undesirable behavior by teaching and rewarding behaviors incompatible with the undesirable behavior. For example, in order to get a child to stop jumping on furniture, reward them for standing on the floor only. For another example, in order to get a child to stop interrupting while on the telephone, reward them for waiting quietly until the phone call is terminated.

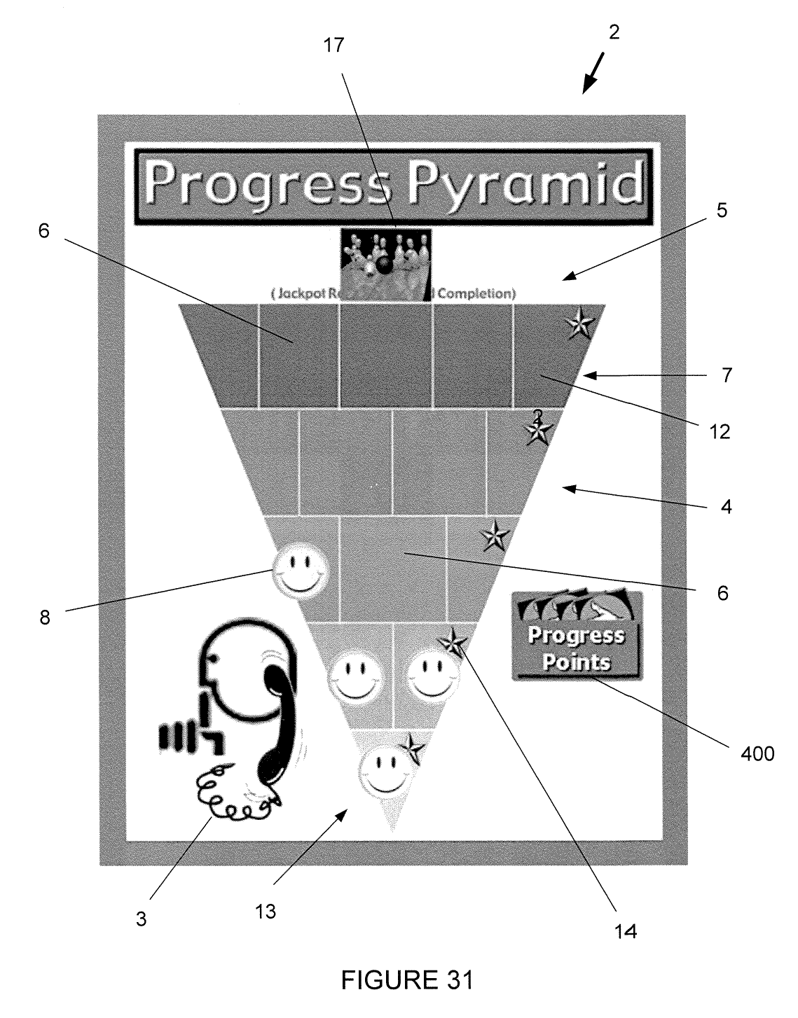

In order to reward progress (such as interrupting people talking on the telephone less frequently, for example) a system of measurement may be included with the progress pyramid chart 2. Depicted in the FIG. 31 is an exemplary embodiment of a progress pyramid chart 2 with progress points 400. Progress points 400 may be any form of tokens or point system which can be used to keep track of a child's progress or “earnings,” including but not limited to coins, buttons, marbles, stones, magnets, or as shown in FIG. 31, slips of papers. Progress points 400 represent cooperation by the child with the chosen objective. In embodiments where points are used, the point total may be written down or otherwise kept track of in some manner (such as with numbers on magnets, slips of paper, or stickers).

In this embodiment, the child is given a tailored number of points or tokens for a predetermined period of time. The number of points or tokens given initially may be determined by the child's ability. Having realistic expectations about a goal or level to which a child is able and likely to succeed is important for winning a child's cooperation.

In one embodiment, parents or caregivers may determine how many deviances from the progress pyramid objective would still qualify as progress based upon the child's history and ability. This number determines the number of tokens or progress points provided or awarded. Thus, in one embodiment, the parent or caregiver provides the number of deviances allowable plus one extra progress point. Caregivers or parents may elect to offer a warning or chance for self-correction before embarking on corrective measures.

In another embodiment, caregivers or parents may randomly reward expectations on the chart 2, generally with gradually decreasing frequency as the skills become increasingly internalized. For each instance in which the child fails to comply with the expectation, he or she must give the caregiver or parent one of their progress points or tokens. The child must have at least one token or progress point left at the end of the time period/activity in question in order to receive a sticker on their progress pyramid chart 2, as indicated above, toward earning a long-term reward. Short-term rewards may be offered for higher performance in instances when minimal requirements for a reward were exceeded. Criteria for a reward may be raised along with increasing ability, by providing fewer tokens or progress points, thereby leaving less margin for error.

A child must retain one or more progress points in order to earn their sticker for the progress pyramid. Every time the child accomplishes the task or skill in question, the caregiver may celebrate with the child or offer the child a suitable reward or treat or reinforcer, and a sticker or marker is placed in the appropriate block in sequence to recognize the accomplishment. In one embodiment, the task or skill in question may comprise the completion of multiple steps or requirements, such as staying close, standing on the floor only, look/not touch, and play “peace” while in town 402. Each skill should be taught individually before having multiple requirements for progress pyramid completion.

In yet another exemplary embodiment, the Progress Points or tokens may come in multiple colors used to represent progress in conjunction with the use of multiple Progress Pyramids.

As discussed above, corresponding stickers or markers may be used for each step or requirement. As shown in FIGS. 31-33, the sequence may begin with the bottommost block, and work up from left to right. Every time a sticker or marker is placed in an end-space (e.g., a block with a star), the child may obtain a significant reward (such as, but not limited to, spending extra quality time with the caregiver celebrating in a special way, a small sum of money, drawing from a surprise jar, gaining access to a special toy, throwing a party, or preparing a special meal).

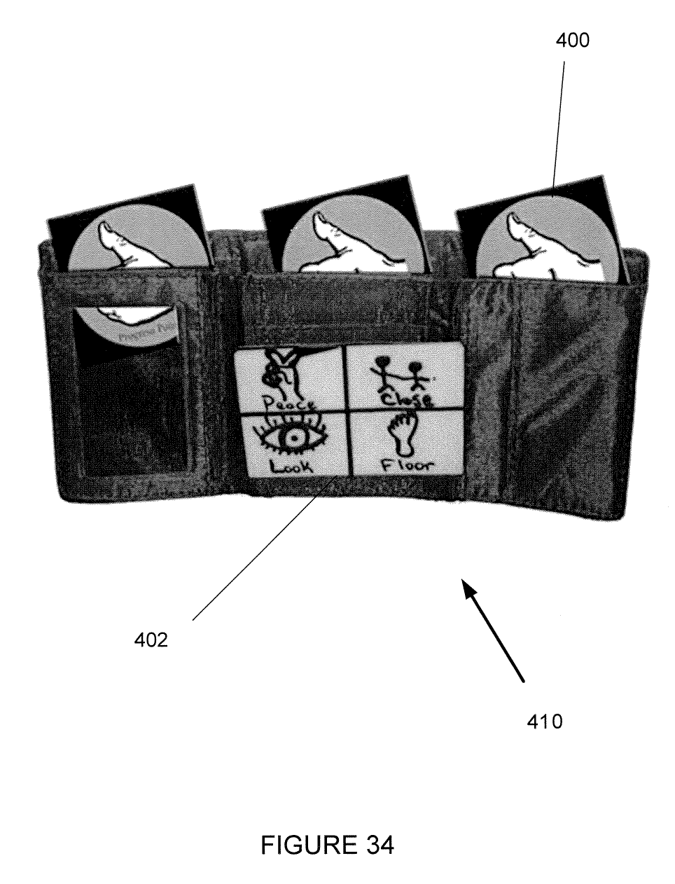

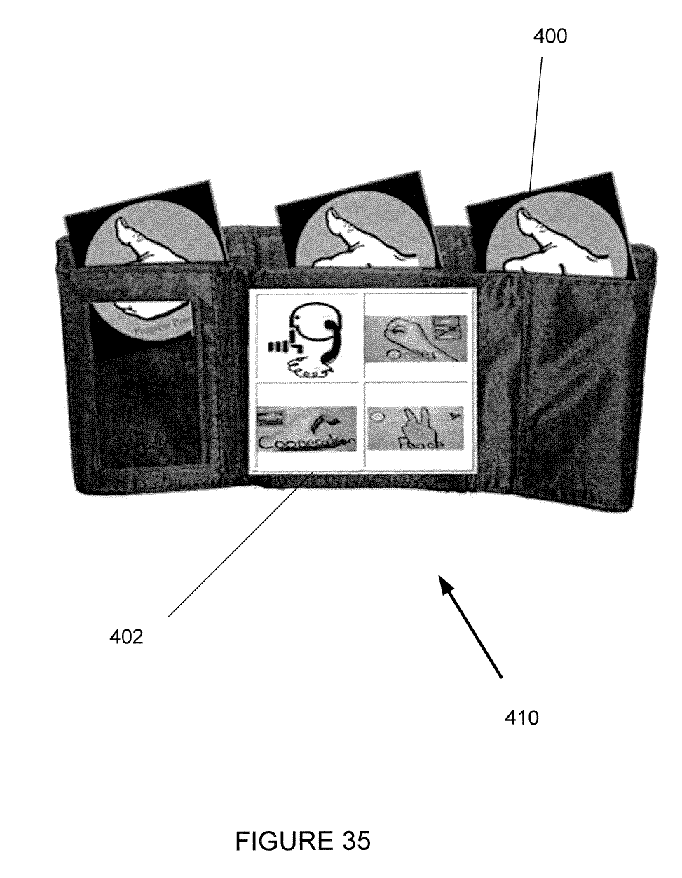

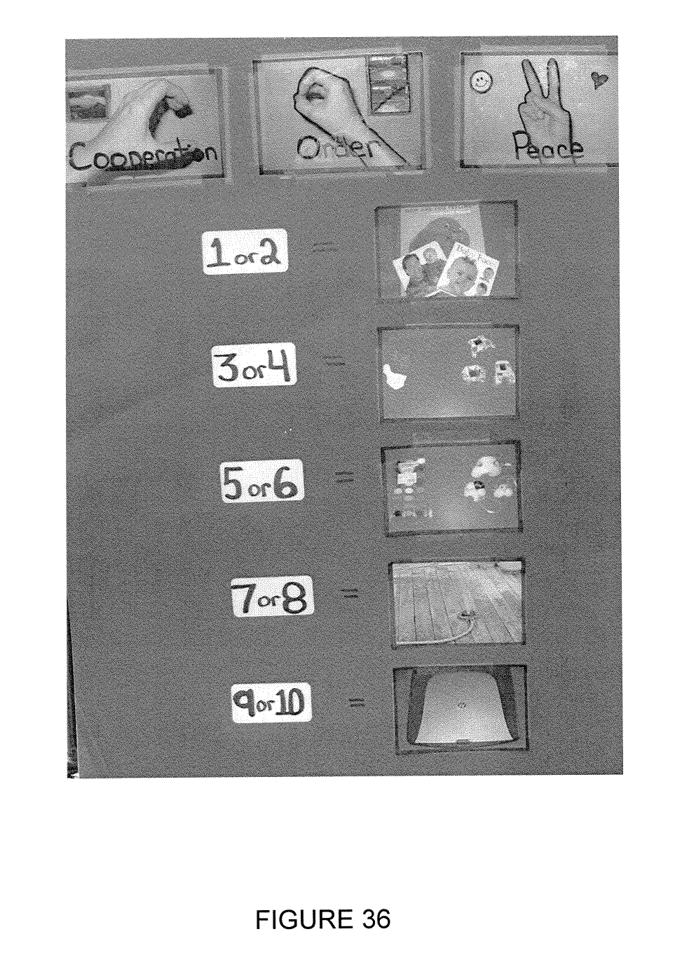

In yet another exemplary embodiment, a travel agreement may be used to facilitate continued progress away from home. As seen in FIGS. 34 and 35, a wallet 410 or other portable container or electronic device may be used to store one or more symbols of agreed upon progress pyramid expectations/goals as well as progress points/tokens to be retained for cooperation or revoked for failure to cooperate with said expectations. Rewards for cooperation and restrictions for failure to meet minimum requirements are determined prior to the time the agreement is in effect.

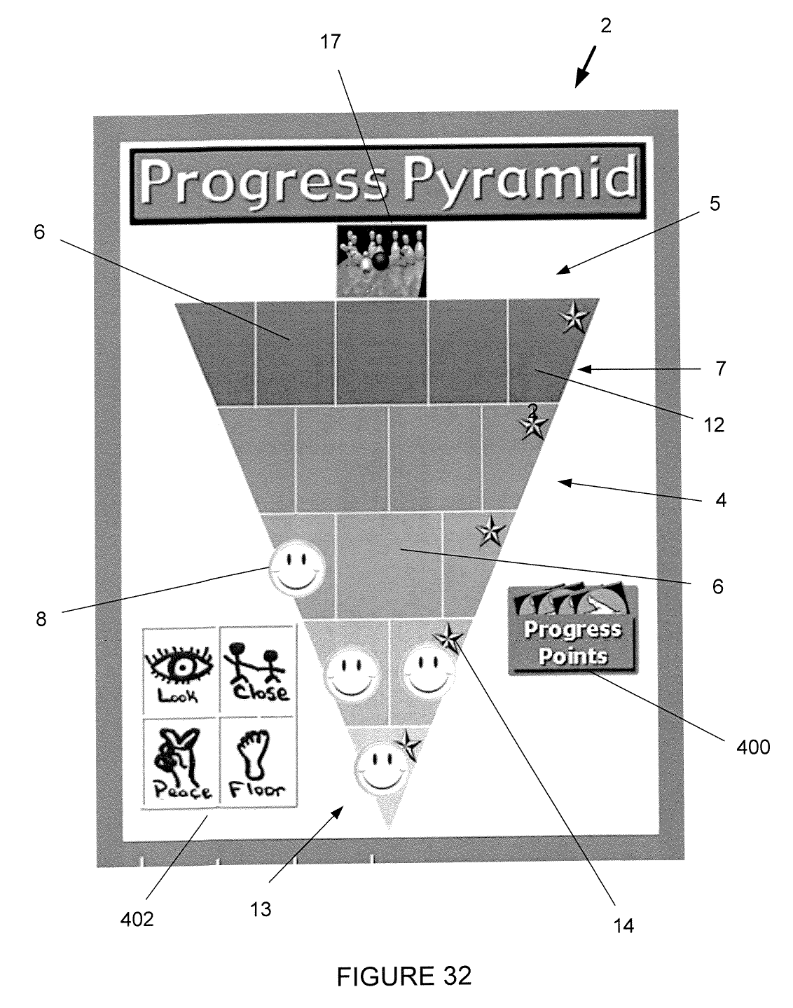

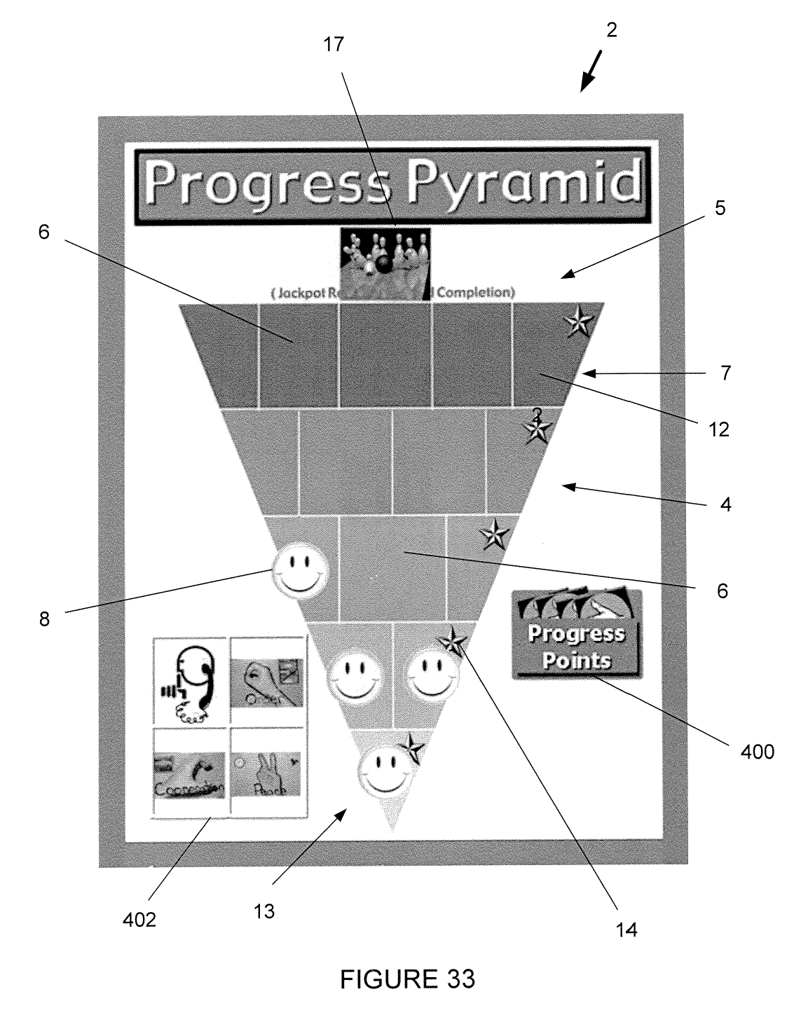

As shown in FIGS. 32 and 33, another embodiment of the progress pyramid is an internalization or ongoing progress pyramid chart, which includes symbols of previously learned skills and values. This embodiment may be similar in appearance to the progress pyramid charts described above with multiple requirements for reward (and a possible travel agreement or wallet form, as shown in FIG. 35). The internalization progress pyramid chart facilitates continued cooperation and internalization after the progress pyramid has been used to teach a skill. The symbols may be rewarded randomly or in a sequence. Symbols may be rewarded with gradually decreasing frequency, in addition to progress point accountability. This embodiment is designed to win continued cooperation after a skill has been learned but not yet internalized. Once the child consistently performs the target behavior with little or no prompting (i.e., there is internalization), expectations can be enforced with graduated restrictions as described hereafter, possibly moving the symbols from the progress pyramid chart or internalization progress pyramid chart to a graduated restrictions chart 20.

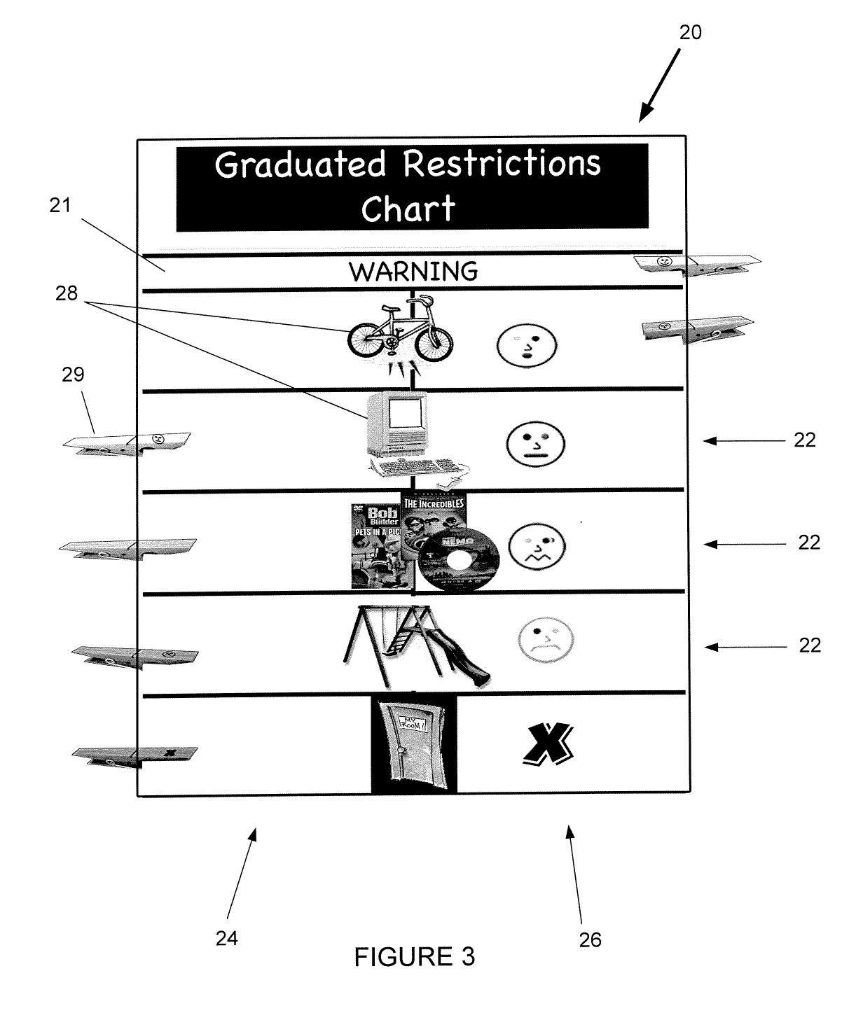

FIG. 3 shows a graduated restrictions chart 20 used for addressing more serious offenses or problem behavior patterns that persist. The graduated restrictions chart 20 should be used on an as-needed basis. In one exemplary embodiment, the graduated restrictions chart 20 comprises a chart with several horizontal rows or layers 22. Five rows or layers, with a sixth “warning” layer 21, are shown in FIG. 3 as an example of one embodiment, although there may be more or fewer. The left and right sides of the chart may be separated and distinguished by some means, such as colors, to indicate acceptable or desirable and unacceptable or undesirable behavior. For example, the color green may be used on the left 24 to indicate acceptable or desirable (i.e., “go” or “cool” ), while the color red is used on the right 26 to indicate unacceptable or undesirable (i.e., “stop” or “uncool” ). These indicators can be reversed, but should be consistent for all layers.

Each layer is marked to indicate a particular privilege or consequence that may be at risk or may result from unacceptable or undesirable behavior. The mark can be a sticker, photo or a picture 28 representing the privilege or consequence, such as a bicycle, computer access or time, a game or movie, play time, cookies (representing a snack), or a particular favorite toy. The bottommost picture 27, in one embodiment, may be a picture representing the child's bedroom or bedroom door, to indicate that the final consequence is playing alone in their bedroom with all toys and privileges lost. As seen in FIG. 3, the sequence of layers in increasing severity of consequence goes from top to bottom, but the sequence may also run in other directions, such as from bottom to top.

A plurality of clips, pins, clothespins, magnets or similar devices 29 are initially fastened to the acceptable or desirable/green side of the chart. As the identified problem behavior occurs, the chart is initially pulled out as a warning and placed in a visible location. In an alternative embodiment where a “warning” layer 21 is used, the chart may be out in a visible location initially, and as the identified problem behavior first occurs, the warning is given by moving the associated clip or pin 29 from the acceptable or desirable side to the unacceptable or undesirable side. Alternatively, this “warning” phase can be skipped for particular behavior, such as aggressive behavior. If the problem behavior occurs again, the pin 29 for the first row is moved from the acceptable or desirable/green side to the unacceptable or undesirable/red side, and the child loses the privilege indicated for that row. As the problem behavior continues, the pins are moved in order from the acceptable or desirable/green side to the unacceptable or undesirable/red side for successive rows, and the child loses successive privileges. Ultimately, all depicted privileges may be lost and the child is confined to his or her room.

Periodically, the chart 20 should be reset by moving all clips to the acceptable or desirable side, and which may also include the chart being put away, so that the child starts with a “clean slate.” The timing of the “clean slate” depends on the age and actions of the child. For example, an older child may receive a “clean slate” at the start of every day. A younger child, however, may be offered more than one “clean slate” a day. For example, the child wakes up each morning with a “clean slate,” and starts with a “clean slate” again after lunch or a nap. The chart 20 may also be kept out of sight unless needed, since it may draw unnecessary attention to the undesirable behaviors being discouraged.

It should be noted that when teaching and integrating new skills, a caregiver or parent may find it particularly useful to first use a standard progress pyramid chart 2 as described above, followed with use of the internalization/ongoing progress pyramid, and further followed with use of a graduated restrictions chart 20, in the event needed.

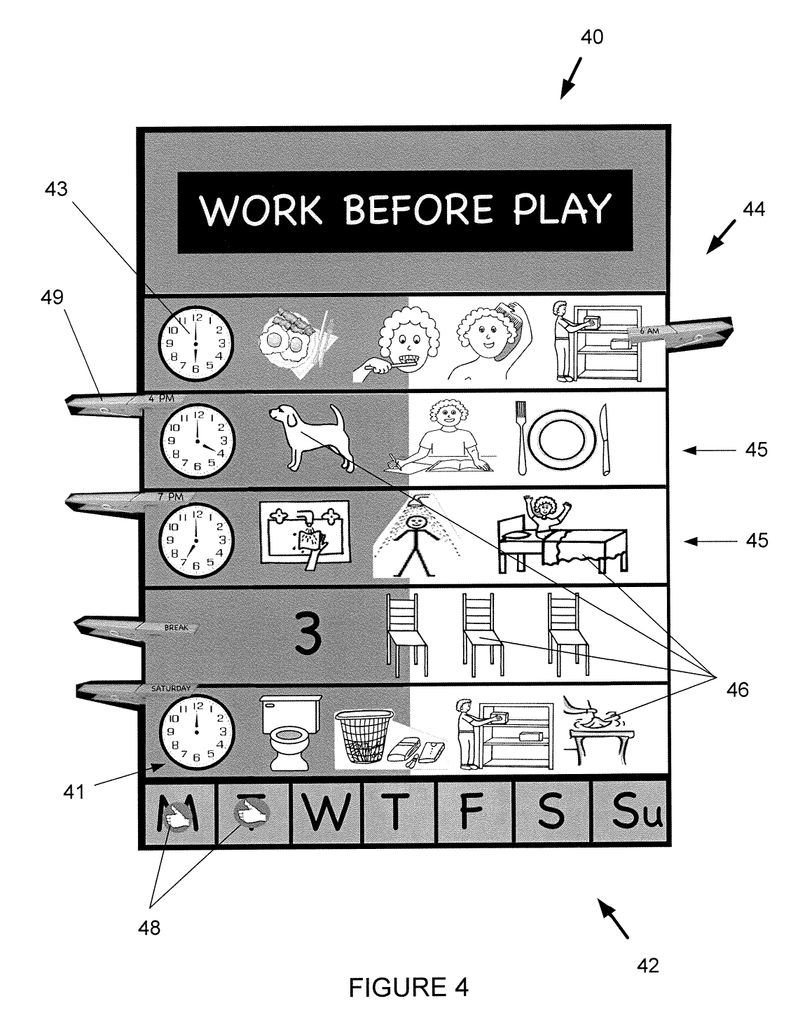

FIG. 4 shows an example of a “work-before-play” chart, or work chart 40. The top part 44 of the work chart 40 is very similar in appearance to the graduated restrictions chart 20 in that it comprises a plurality of layers or rows 45, and also may use pins 49. The bottom part of the work chart 40 comprises a row of boxes 42 representing the days of the week. This week row 42 may comprise a separate box for each day of the week, as shown in FIG. 4, and each box may be individually colored or all boxes may be the same color. In an exemplary embodiment, the week row 42 is a color, such as yellow, that distinguishes this row from the top part of the work chart 40.

Each row in the top section 44 is marked to indicate a responsibility or task, or several responsibilities or tasks. The mark can be a sticker, photo, magnet or a picture, or a combination of these 46. The responsibilities may be performed at different times of the day, or be a day-long responsibility. As seen in FIG. 4, the first row represents morning responsibilities (e.g., getting dressed, eating breakfast, brushing teeth, combing hair, straightening room), the second row represents afternoon responsibilities (e.g., feeding the dog, doing schoolwork, helping set the table), and the third row represents evening responsibilities (e.g., washing or bathing, brushing teeth, dressing for bed). The fourth row represents “going to break” or “time-out” fewer than a set number of times per days (FIG. 4 shows 3 times, but the number can be larger or smaller). The concept of “going to break” is described below. The fifth row in FIG. 4 represents Saturday or weekend responsibilities, which often are a bit more intensive (e.g., change sheets, dust and vacuum room, and similar activities). The time to perform these duties can be negotiated and agreed upon by the child and the caregiver.

Each row has a place 41 to show the time by which each set of tasks should be completed. The time can be represented by a clock 43 or a numeric representation. The clock 43 can be a sticker or marker from a plurality of stickers with typical times pre-marked, or a clock face on which clock-hands can be drawn or stuck (in embodiments where the clock-hands are stickers or the like). The time can be shown in a separate block or section 41 of the row as shown in FIG. 4, or can be integrated into the row itself. While FIG. 4 shows the time element on the left side of each row, the time element can be located anywhere in or near the corresponding row, including in the center or on the right side.

Each layer may be individually colored, and each layer may be uniformly or variably colored. In one exemplary embodiment, each layer may be bi-colored, with a red or similar color used on the left half of the layer to indicate or warn that a task still needs to be done, while a green or similar color is used on the right side to indicate that a task has been completed. Other colors may be used, and the order may be reversed.

In another embodiment, the pin or clip 49 associated with each responsibility or task row may be color-coded. In one embodiment, for example, a first color might correspond to morning responsibilities, a second color might correspond to afternoon responsibilities, a third color might correspond to evening responsibilities, and so on. The colors may correspond to the colors of the corresponding row, if the rows are colored.

In one exemplary embodiment, the child is involved in setting up and negotiating the responsibilities included on the work chart 40. The work chart may then be placed in a visible location, and initially, the child may need to be reminded about the agreement and particular tasks as he or she adjusts to the new structure. Eventually, the child may be notified that he or she will be responsible for remembering to accomplish the tasks, and if a reminder is necessary, some consequence will occur (e.g., an extra 30 minutes without privileges, etc.).

The day is begun with the clips 49 on the red/not-done side (which may be the left side, as seen in FIG. 4), to indicate that the task or responsibility marked for a row still needs to be accomplished. As a task is completed, the clip is moved from the red/not-done side to the green/done side. In order to encourage timely completion of tasks, all or some privileges may be put on hold at designated times until the corresponding tasks or responsibilities are completed. If a “go to break” row and clip is used (the fourth row in FIG. 4), the clip gets moved to the green/go side in the evening if that expectation has been met.

For each day in which a specific number (which may be all) of clips has been moved to the “task completed” or green side, a sticker or similar marker 48 is placed on the corresponding day of the week row. Any appropriate sticker or marker may be used; FIG. 4 shows a “thumbs up” sticker, as a nonexclusive example. The child may also be offered a short-term reward for that day, such as an extra story at bed time or being allowed to stay up an extra 30 minutes. The child may be offered a reward at the end of the week based on the number of daily stickers or markers collected during the week. In general, the greater the number of daily stickers earned, the greater the reward. In one embodiment, the parent and child may agree in advance as to the rewards to be gained, and pictures or symbols may be added to the chart to symbolize this agreement.

Once a child is consistently performing the tasks on the work chart 40, the chart may be put away for a trial period, or the tasks may be replaced with new tasks. The child's response to the decrease in structure will determine whether he or she is ready for this additional freedom and/or responsibility.

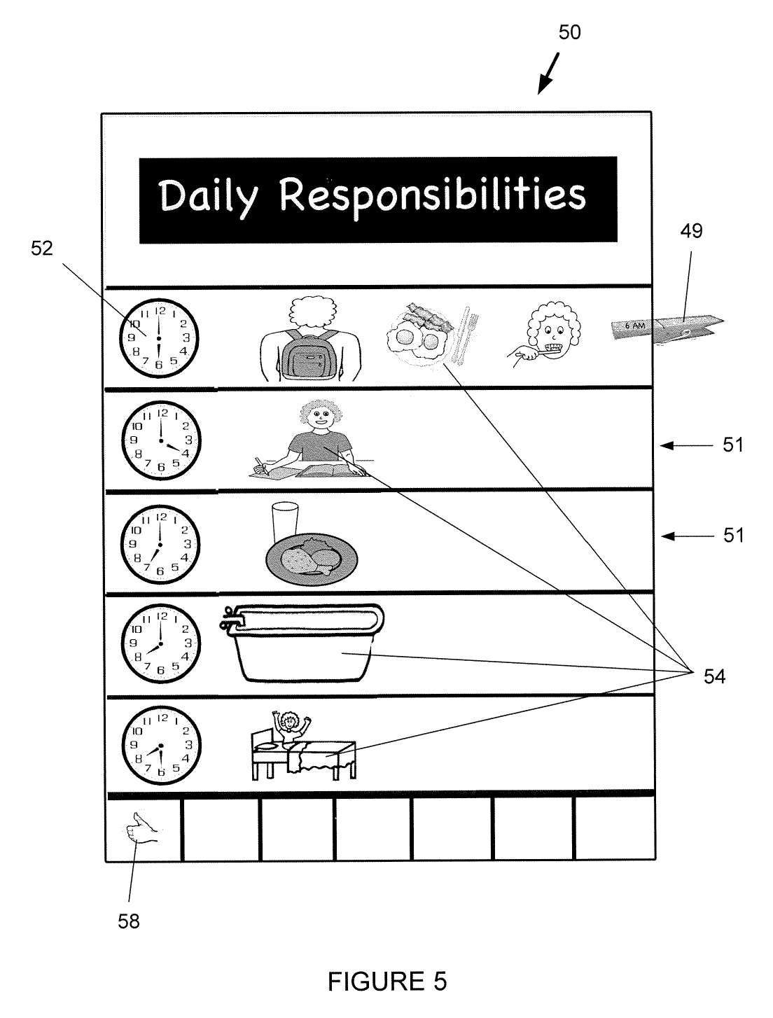

FIG. 5 illustrates one embodiment of a “daily responsibilities” or “daily routine chart” 50 used to clarify and strengthen daily family routines. The daily routine chart 50 is similar to the work chart 40, although in one exemplary embodiment the background and colors used may be more neutral. In another embodiment, the daily routine chart 50 may not be specific to a particular child, but may instead encompass the family.

Each row 51 of the daily routine chart 50 corresponds to a time period in which certain tasks must be accomplished. Each row may have a clock or numeric time 52 with pictures or symbols of the different tasks 54 to accomplish by that time. For example, as shown in FIG. 5, the first row shows that at 6 am the expectation is that a child will get up, brush teeth, eat breakfast, and have his or her backpack ready for school. Other similar tasks that may be shown include, but are not limited to, feeding the dog, making the bed, getting dressed, and the like. The second row shows that by 4 pm the child will begin their homework. The third row shows that dinner is at 7 pm. The fourth row shows that bathing for bed is at 8 pm, and the fifth row shows that the child will be in bed by 8:30 pm. Other stickers or markers may be used in each row, and the times will vary for each child or family.

Stickers or markers, such as a “thumbs up” sticker 58, may be used for each time period in which all (or a certain number of) tasks are completed as scheduled. As shown in FIG. 5, these stickers are placed in a bottom row 55. FIG. 5 shows seven spaces in the bottom row 55, but any number of spaces may be used. Privileges and rewards can be awarded based on the number of stickers or markers earned. Over time, the expectations for compliance may increase, so that meeting the daily routine chart requirements eventually becomes an expectation that is randomly rewarded. For occasional non-compliance, a “go to break” or graduated restrictions chart 20 may be used, while the work chart 40 may be used for persistent problems with a particular child. Clips 49 may also be used in a similar manner as in the work-before-play chart.

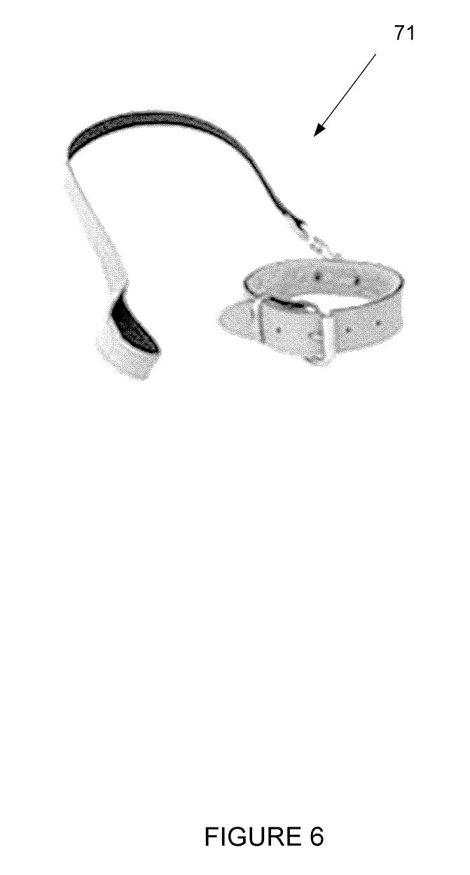

As shown in FIG. 6, an additional component that may be used comprises a tether, leash or similar physical restraining device 71 that may be used with young children to teach self-restraint. Beginning tether work would include games to teach the child to “stop” and “stay close” (or similar commands). The tether can also be used to teach the child to stay within arm's reach or to stay within a specific area.

The process for teaching a child to stay within a specific area with a tether is as follows. When away from home, initially contain the child with the tether. Show the child which areas are permissible or “cool” (perhaps using a “thumbs up” hand signal) and show which areas are off limits or “not cool” (“thumbs down” signal). For example, in a yard, the grass may be “cool” while the concrete of a sidewalk or driveway may be “not cool” After identifying the limits, the tether may be removed. The child should be praised and rewarded for self-containment by staying in the permissible areas. The extent to which the child should be watched after removing the tether varies depending on the behavior of the child, and the area in question.

If the child goes out of the permitted area, the child should be politely requested to return and stay within the bounds of the permitted area. If the child does not respond, a countdown ensues. Typically, this involves a count to three, starting with one and pausing one to two seconds between numbers. (This assumes that the child previously has been taught to expect adverse consequences to happen on the count of three.) In general, the parent should avoid talking to, threatening or yelling at the child while counting, or stopping the count unless the problem behavior has ceased. Upon reaching three, the child should immediately be placed in break on the tether, without emotion from the parent. An automatic break may be used for recurrent instances of undesirable behavior, without counting to three.

The tether/break places the child back on the tether in a break or “time out” period. The period may last for one minute per year of age of the child. Alternatively, when first learning about limits away from home, the break period may be 30 seconds. For more spirited children, or children accustomed to the tether, the length of the period may correspond to the number of the offense, e.g., one minute for the first offense, two minutes for the second, etc. Upon completion of the period, the tether may be removed. A verbal code or hand signal may also be used to indicate unrestricted free play. The tether/break may be repeated as needed until the child co-operates and self-contains.

The process for teaching a child to stay within arm's reach generally follows the same process as teaching to the child to stay within a specific area. Use the tether to keep the child close, and teach the child what it means to “stay close.” In the early stages, reinforce desired behavior using praise and rewards for staying close or within arm's reach. Tether/breaks may be used as described above when the child moves outside this range. The goal is to teach the child that he or she has the choice of walking freely within arm's distance (i.e., self-containment) or being placed on a tether (i.e., containment).

When the child generally self-contains, self-containment can be considered an expectation, especially when cued or triggered. At this point, rewards may no longer be offered for staying within particular limits (although rewards may be awarded on occasion for consistency, improvement, or exceptional behavior). Graduated restrictions and/or breaks on the tether may be used for failures to self-contain.

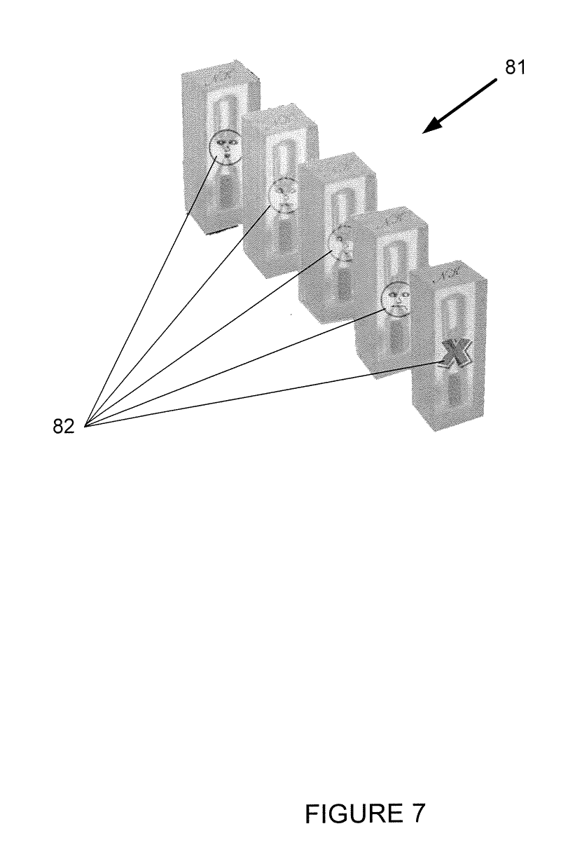

FIG. 7 shows color-coded sand timers 81 that may be used with the 1-2-3 technique described above, although use of the technique is not limited to tether work and may be used to correct behavior in many other situations. The initial step in the technique is an attempt to allow self-correction of the behavior with a polite request or instruction. The word “please” may be used, and can be a known code word for “This is a warning.” If the child does not respond to the request, the parent or caregiver begins counting to three in a slow, measured fashion, with one to two second intervals between the numbers. The parent or caregiver should avoid threats, talking, or stopping the count, unless the problem behavior has ceased. Upon reaching three, the parent or caregiver immediately, and without emotion, places the child in break.

The color-coded sand timers are used during the break to establish the length of the break. The colors correspond to the severity of the misbehavior and thus, the length of the break. Other symbols, such as emoticons or symbolized faces 82, may be placed on the timers to reinforce the level of restriction. In general, the amount of the break time increases with each timer. In one exemplary embodiment, the color sequence for a set of four timers in increasing severity is blue, yellow, red, and black. If symbols or emoticons are also used, the matching sequence would be a face with an “uh oh” expression, a face with a straight line for a mouth, a face with a sad or unhappy expression, and a bold “X”. The last timer may be for a suitably long period of time, or may result in the child being sent to his or her room until a lengthy period had passed (or, if the behavior is associated with a chart as described above, until the next “clean slate”). The timers, then, in one embodiment, may be considered a form of graduated restriction.

It should be noted that the clips 29 on the graduated restriction chart (as described above) may also be color coordinated to correspond to the sand timers 81. As each clip 29 is moved to the unacceptable or undesirable side of the chart, it is accompanied by a break and loss of privileges using the corresponding sand timer 81. If colored clips are used, a green clip with a smiley face may be used on the chart as the first clip. When the chart is first pulled out or being used in response to some undesired behavior, the green clip may be moved to the unacceptable or undesirable side as an initial warning.

The number of sand timers 81 may vary, as may the colors. For example, three to five timers can be chosen to correspond to three to five corresponding clips. The number of timers and clips can depend on the circumstances. For example, younger children or children with a long history of misbehavior may need a few more chances before the ultimate sand timer/consequence is reached. Thus, a fifth sand timer could fit in between the yellow and red timers; its color may be orange, and may have a face with a squiqqly line for a mouth.

Other forms of timers other than sand timers, such as electronic or wind-up timers with a signal when time is up, for example, may be used.

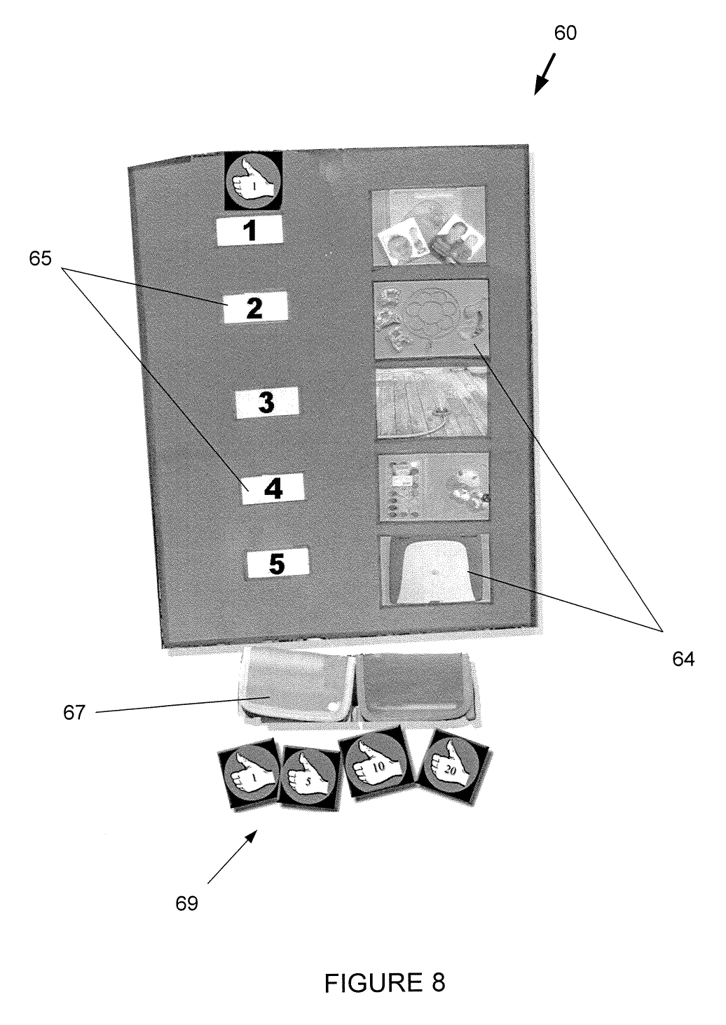

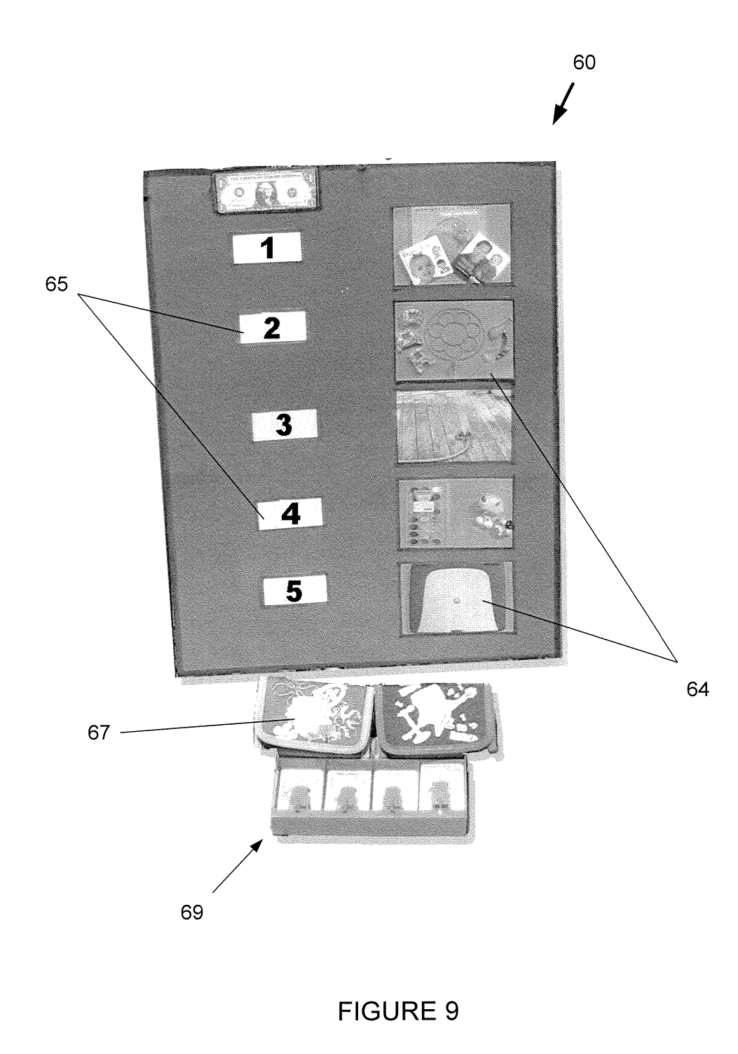

FIGS. 8 and 9 illustrates two embodiments of a point-based or token-based system 60 for rewarding children. In general, a child earns points or tokens of some type to be exchanged for rewards at a later time. The system comprises a chart with a list of rewards to be earned 64, and the number of points or tokens needed 65 to achieve that reward. As children accumulate points or tokens, they save the points or tokens until they decide to spend the appropriate number of points or tokens to receive the chosen reward. If tokens are used, tokens can be anything used to keep track of a child's earnings: coins, buttons, marbles, stones, vouchers, or the like. If points are used, the point total may simply be written down or otherwise kept track of in some manner (such as with numbers on magnets or stickers). In one alternative embodiment, the tokens can be the pieces of a puzzle, and the puzzle once completed is a picture of the reward. Once the puzzle is completed (i.e., all the puzzle pieces have been earned), the reward may be received.

Point markers or tokens may be stored in a rack or stack 69 below or near the chart. As points or tokens are awarded, the child places the point marker or token in a wallet 67 or other container for storage. Tokens or points may be received for specific behavior, or as a random reward by the caregiver for desirable behavior. Randomly rewarding desirable behavior reinforces the desire to act in an acceptable or desirable manner at all times.

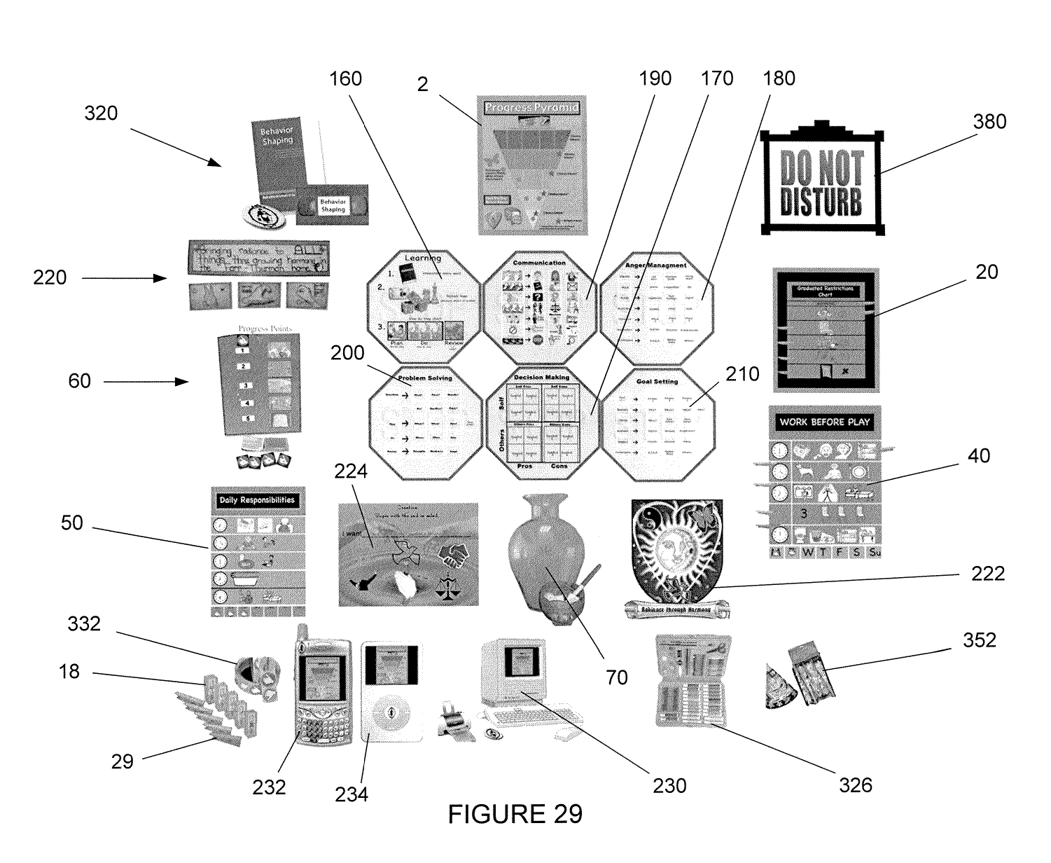

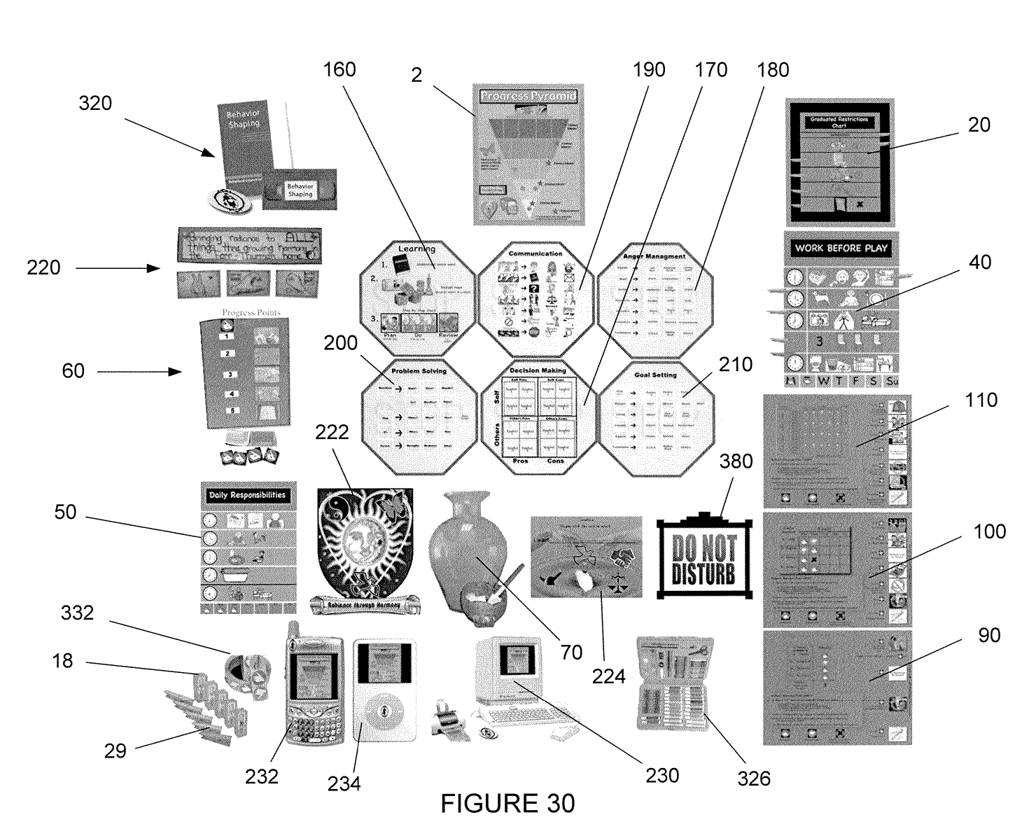

In another alternative embodiment, as seen in FIGS. 29 and 30, at the top may be a row with pictures or symbols representing family guidelines or goals. The number and nature of these guidelines may vary from family to family and generally evolve as family members mature. FIGS. 29 and 30 show a non-exclusive example of a set of three family guidelines representing “peace,” “cooperation,” and “order.” The pictures in the example show hand gestures and other symbols representing each guideline. These hand gestures and other symbols may include standard, recognized sign language, and thus may be used to teach some principles of sign language.

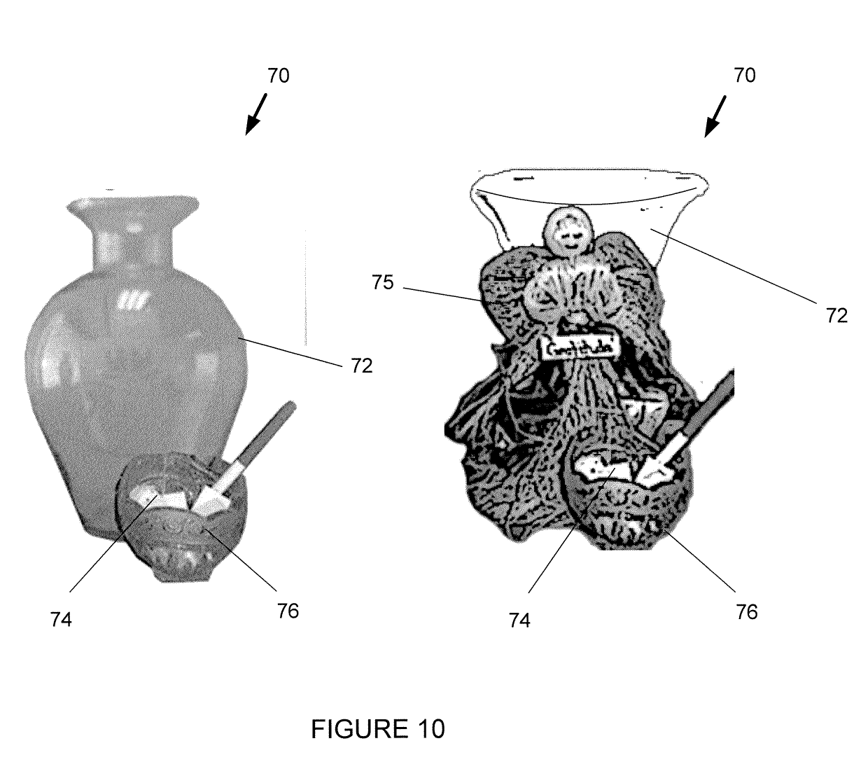

FIG. 10 illustrates a “gratitude jar” 70. A gratitude jar comprises any form of container 72, including a jar such as a cookie jar, into which family members place slips of paper or other writing material 74 on which they have described what they are grateful for. The indication can be in writing, or a picture or symbol of some sort, and may be shared with other family members. Blank sheets of writing material 74 may be keep in a container or bowl 76 adjacent or near to the gratitude jar container 72. As the paper slips 74 accumulate, the jar becomes visibly fuller. On occasion, the jar may be emptied in some form of gratitude ceremony. The gratitude ceremony disposes of the slips of paper 74 in some appropriate way, such as by burning in a safe location, and may include the offering of thanks. The jar can be decorated or marked or decorated, such as with a FIG. 75 as seen in FIG. 10, and can be made of any appropriate material.

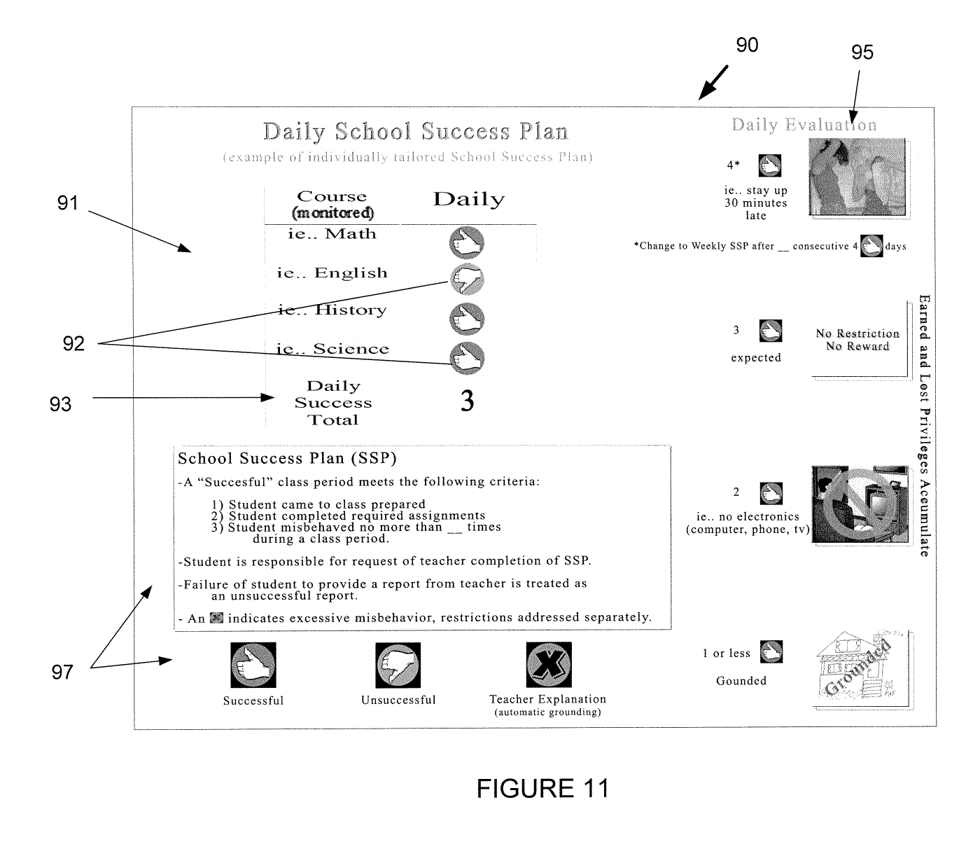

FIGS. 11-13 show a series of school success charts or plans. These charts are used to monitor school work on a daily, weekly, and monthly basis. The charts can vary according to individual needs and characteristics.

FIG. 11 illustrates an exemplary daily school success plan and chart 90 comprising a course monitoring table 91. The course monitoring table 91 comprises a plurality of rows, with particular rows corresponding to a particular course. A sticker, magnet, or marker 92 is placed in the space in each course row to indicate how the child did that day. In one embodiment, this is based on a daily report from the teacher of that particular course, which may be communicated in writing, via email, orally, or by telephone. The student may be responsible for requesting teacher completion of the daily report. At a simple level, a successful sticker may be obtained if the child came to class prepared, completed required assignments, and misbehaved no more that a set number of times during a class period. Failure of the student to provide a report from the teacher may be treated as an unsuccessful report. A “teacher explanation” report can be used for severe or excessive misbehavior, with appropriate consequences (such as automatic grounding). The course monitoring table 91 may comprise a summary row 93 showing the total number of successes for the day. In one exemplary embodiment, instructional material 97 may be shown.

Certain rewards or consequences may be received based on the daily success total, and may be shown in a list or table 95. For example, as shown in FIG. 11, a daily success total of 4 (or the maximum possible for the day) may result in the child being able to stay up 30 minutes later than normal, while a daily success total of 3 may be considered normal, with no positive or adverse consequences. A daily success total of 2 may result in some restrictions, such as no electronics usage, while a daily success total of 1 or less may result in the child being grounded. Each day, the daily school success plan begins anew. In one embodiment, the gains and losses of privileges may be cumulative.

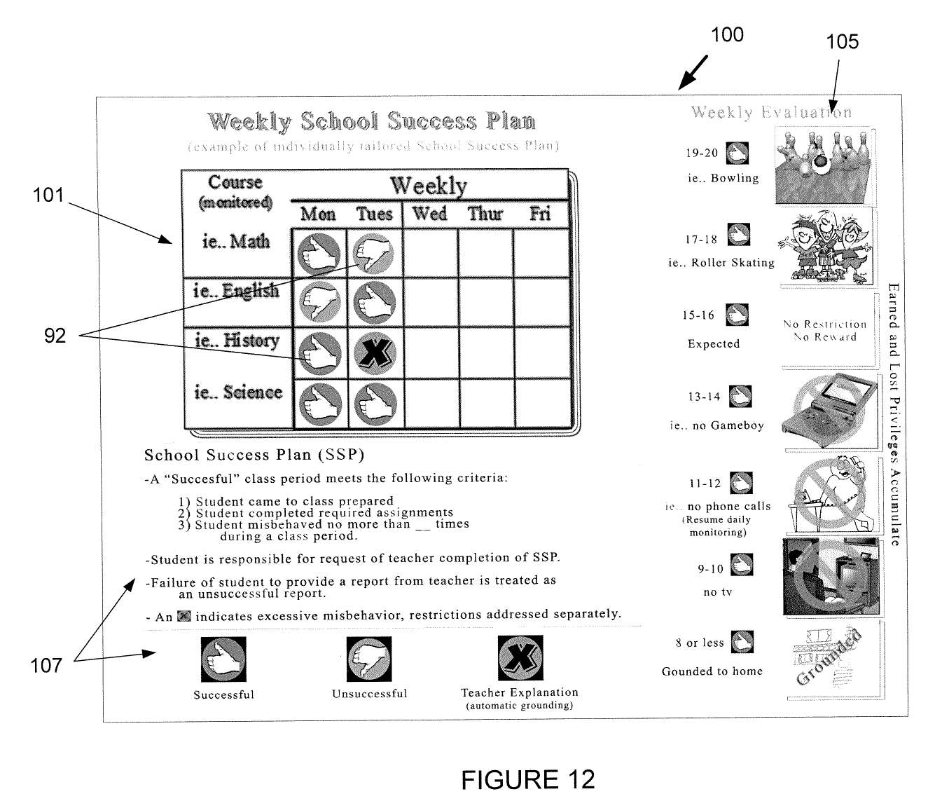

FIG. 12 shows how successful and unsuccessful reports are accumulated over a week using a weekly school success chart 100. A weekly course monitoring table 101 is used covering the same courses as in the daily course monitoring table 91, except that spaces are provided for each day during the week. Privileges and consequences 105 may be received at the end of the week based on the weekly success total. For example, as shown in FIG. 12, a daily success total of 19 or above is rewarded with a special activity (such as bowling), a total of 17-18 is reward with another activity (such as roller skating), a total of 15-16 is normal with no positive or adverse consequences, a total of 13-14 results in the loss of a privilege (such as playing with the child's Gameboy), a total of 11-12 results in a greater loss of privilege (such as no telephone calls), a total of 9-10 results in an even greater loss of privilege (such as no TV), while a total of 8 or less results in grounding. As noted above, in one embodiment, the gains and losses of privileges may be cumulative. In another exemplary embodiment, instructional material 107 may be shown.

In one exemplary embodiment, a child starts with both the daily school success plan and weekly school success plan being used (or just the daily school success plan). After a certain number of consecutive days (FIG. 11 shows 4, although some other number may be used) of achieving the top level of daily success totals, use of the daily school success chart may cease, and the weekly school success plan may be continued (or started, if just the daily plan was used to begin). Use of the weekly school success plan may continue, with use of the daily school success plan being resumed if the weekly success total is below a certain number (FIG. 12 shows that daily monitoring is resumed if the success total is 12 or below, but this number can vary).

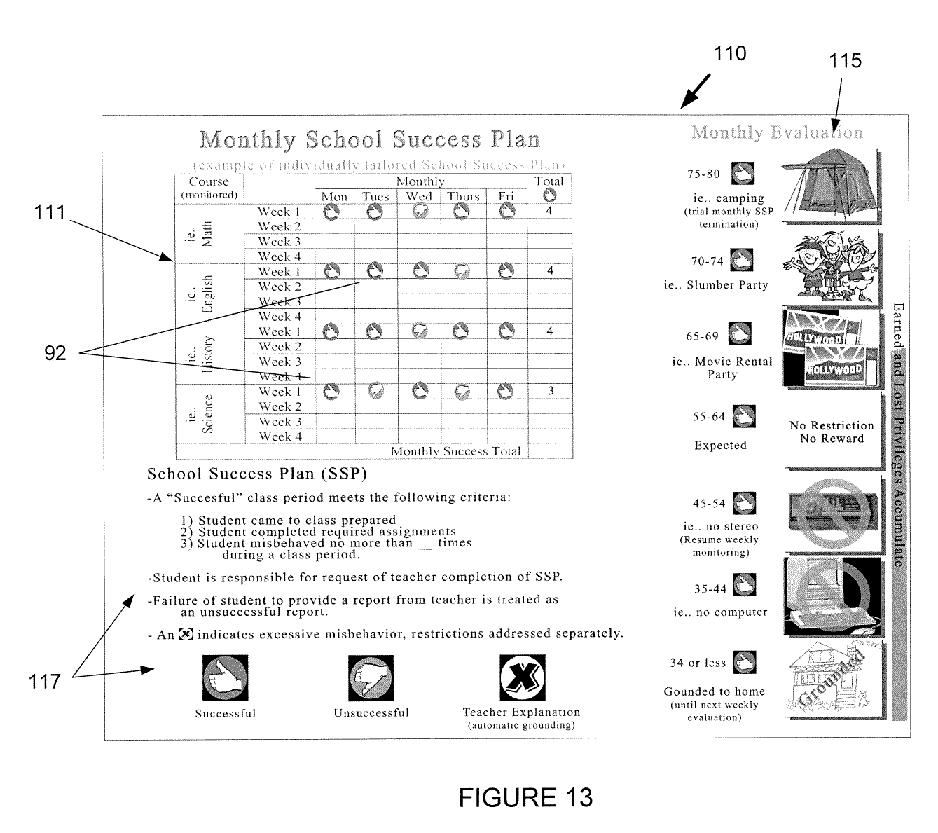

FIG. 13 shows one embodiment of a monthly school success plan 110 used to keep track of successful and unsuccessful reports for a month or four/five-week period. In the embodiment shown in FIG. 13, rows of weeks in the course monitoring table 111 are organized by course, although the table can be organized by week so that each week has a row for each course. Appropriate stickers or markers 92 are placed in the space for each course and week-day combination, and weekly totals can be kept. As with the daily and weekly charts, a variety of rewards or adverse consequences 115 can result depending on the monthly success total.

The school success plans my be used individually or in various combinations. Similar to the method described above, in one exemplary embodiment, use of the weekly school success plan can be ceased after a certain level of repeated success is seen. Monitoring then can be solely through the monthly school success chart, although as seen in FIG. 13, weekly monitoring may resume if the monthly success total for the month is below a certain number. Ultimately, a high monthly success total may result in cessation of the monthly school success plan, at least on a trial basis.

The use of the above plans will vary depending on the child and the child's needs, and are particularly designed to address academic issues where a child is not making a sincere effort to succeed. Thus, how often the school success plans are monitored can vary, as can the number of classes monitored (not all classes need be monitored), the types of rewards gained or privileges lost, the number of successful classes used to measure rewards or lost privileges. In one embodiment, expectancies can be increased over time, so the number of successful classes needed to achieve a particular level can be increasd.

It also should be noted that standard for achieving a successful report is based on the effort put forth by the child (i.e., preparing for class, completing assignments, behaving within reason). If a child is making a sincere effort, yet continues to make poor grades, this generally indicates that special or different needs or problems may be at hand, such as sleep issues, learning differences or disabilities, nutritional issues, and the like.

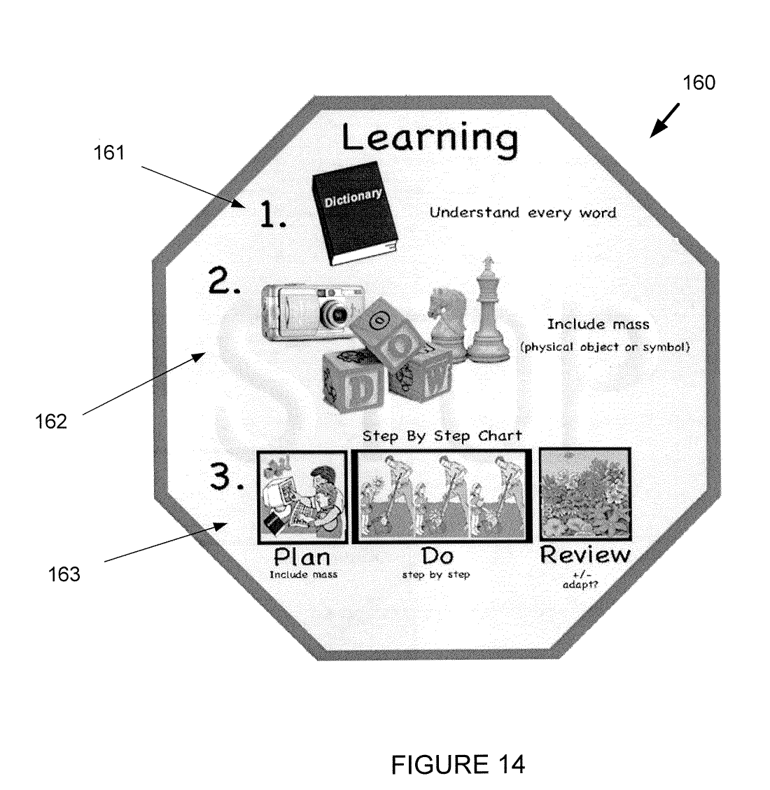

FIGS. 14 through 19 show various embodiments of additional components addressing or covering enhanced living skills, such as a learning chart 160, decision making chart 170, anger management chart 180, communication chart 190, problem solving chart 200, and goal setting chart 210. In general, the general form of the enhanced living skills charts is a column of words or symbols on the left indicating questions or issued to be addressed, with a number of rows or columns of spaces on the right side for the placement of symbols or words.

FIG. 14 shows one embodiment of a learning chart 160. The chart may be used as a tool to be used when embarking on learning any subject (or subjects). The first step 161 in using the chart is to ensure that the user completely understands all instructions or information provided. As a nonexclusive example, as seen in FIG. 14, when instructions or information is provided in a written or verbal manner, this could include learning every word, with the intent being to ensure that every word is understood, which may be accomplished by looking up in a dictionary every word that is not understood or that is confusing. The second step 162 is to “add mass” by adding words or symbols to represent or symbolize the elements being studied in order to facilitate learning. The third step 163 is to create a plan or chart one's course of study, proceeding stepwise with the most basic concepts and moving in order to progressively more difficult concepts. Symbols or words representing these steps are added to the chart.

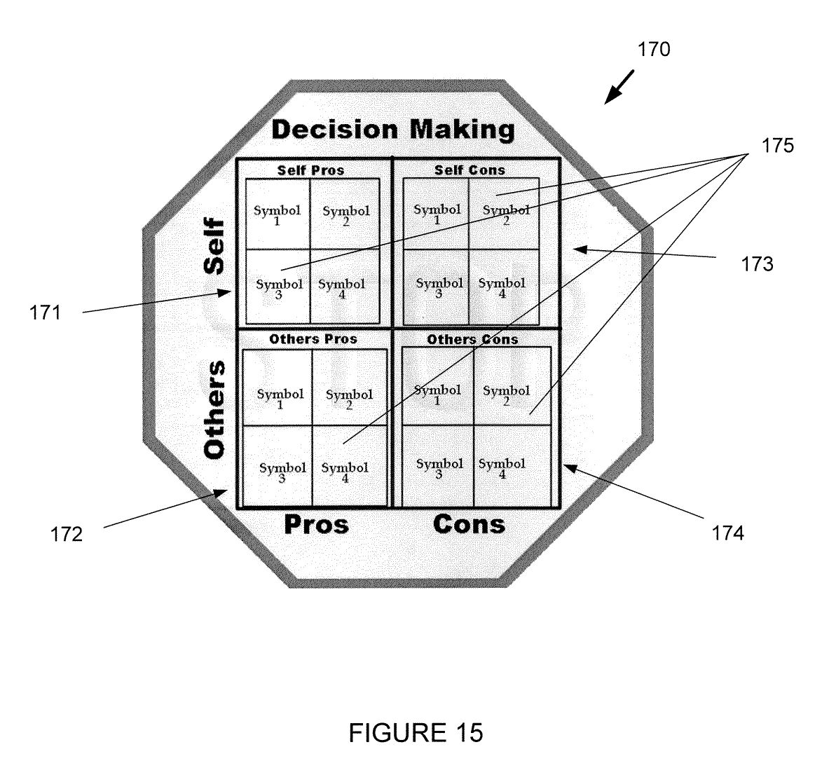

FIG. 15 shows one embodiment of a decision making chart 170. In general, when faced with a decision, the first step is to generate as many feasible options as possible. The decision making chart 170 comprises four sections representing the positive and negative (i.e., benefits and problems) aspects of various options for ones' self and for others. In the embodiment shown in FIG. 15, the top left section 171 is used for showing benefits for the individual, while the bottom left section 172 is used for showing benefits for others. The top right section 173 is used for showing problems for the individual, while the bottom right section 174 is used for showing problems for others. The placement of these sections can vary in other embodiments. Words, pictures or symbols, or some combination thereof 175, may be used to represent these benefits and problems, and can be placed in the appropriate section for each option (in some embodiments, multiple options can be considered simultaneously) . The chart can then be used to visually weigh the relative positive and negative aspects of the various options.

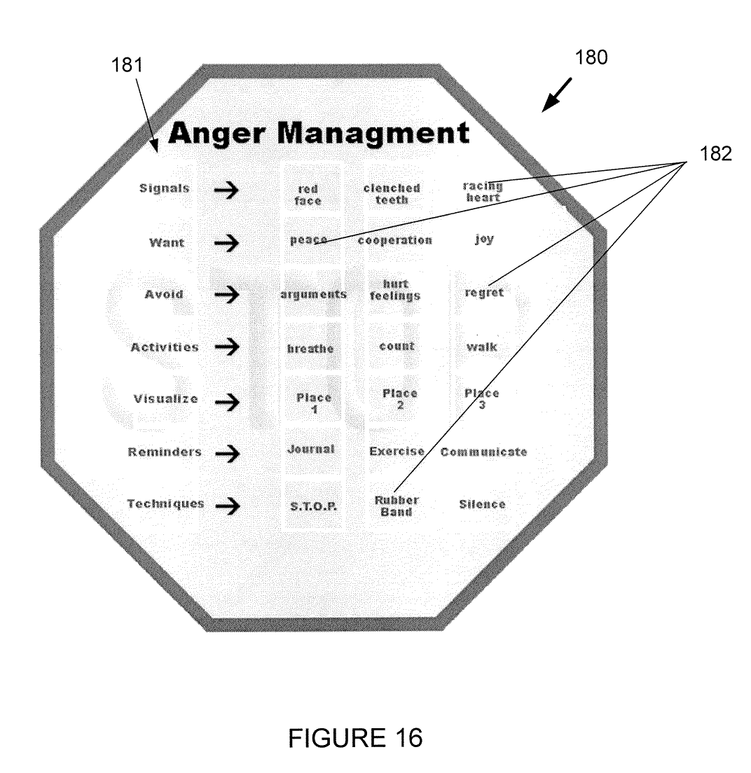

FIG. 16 shows one embodiment of an anger management chart 180. Along the left side is a list or column 181 of questions or issues to address. First, identify the physical signals that indicate anger for the individual. These signals will vary by individual, and can include, for example, a red face, clenched teeth, racing heart, etc. Symbols representing these signals are then affixed in the appropriate spaces 182 on the chart. Second, identify what one wants in terms of relating to others when angry (e.g., peace, cooperation, joy, composure, etc.), and apply appropriate symbols for these to the chart in the appropriate spaces. Third, identify what one wants to avoid (e.g., arguments, hurt feelings, regret, etc.), and apply appropriate symbols for these to the chart in the appropriate spaces. Fourth, identify what activities the individual can do to “defuse” when angry (e.g., breathe, count, go for a walk, etc.), and apply appropriate symbols for these to the chart in the appropriate spaces. Fifth, identify places that one can visualize and imagine that they are in when experiencing anger or stress (e.g., the beach, a spa, a garden, etc.), and apply appropriate symbols for these to the chart in the appropriate spaces. Sixth, identify ways of expressing anger or similar feelings that are not destructive (e.g., writing in a journal, exercising, controlled communication, etc.), and apply appropriate symbols for these to the chart in the appropriate spaces. Seventh, identify techniques to assist in managing anger (e.g., STOP, the rubberband technique, or practicing silence), and apply appropriate symbols for these to the chart in the appropriate spaces.

The STOP technique uses the letters in the word to teach discernment. The letters stand for “Stop, Think, Options, Plan.” It is a easy mnemonic to remember: stop, think about the situation, consider several options, and develop a plan to follow. The rubberband technique has the individual wear a rubber band on a wrist when modifying a personal pattern. Each time a thought or behavior that is counter to the intended goal occurs or takes place, the individual gently snaps the rubber band as a self-corrective way of enhancing memory regarding what is desired. The individual then thinks or communicates an appropriate alternative to the undesirable thought or behavior.

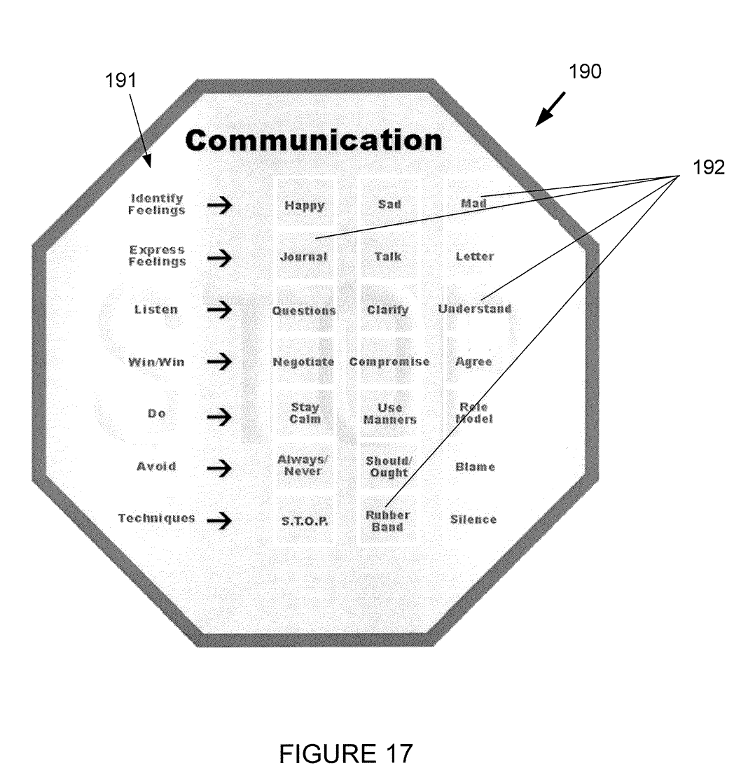

FIG. 17 shows one embodiment of a communication chart 190. Along the left side is a list or column 191 of questions or issues to address. First, identify your feelings (e.g., happy, sad, mad, etc.), and apply appropriate symbols for these to the chart in the appropriate spaces 192. Second, express your feeling using “I” terms (e.g., “I feel______,” “I want______”), determine helpful means of expressing yourself (e.g., journal, letter, email, talking), and apply appropriate symbols for these to the chart in the appropriate spaces. Third, identify ways to actively listen to others (e.g., be willing to listen first, ask questions and clarify what is said to be certain that the parties understand the other point of view correctly, respond to the content, etc.), and apply appropriate symbols for these to the chart in the appropriate spaces. Fourth, affix symbols to the chart representing what it means to seek win/win solutions in which each party is satisfied that their needs are being met. Fifth, affix symbols to the chart representing communications principles to focus on (e.g., staying calm, using manners, role modeling). Sixth, affix symbols of behaviors to be avoided (e.g., speaking in extremes of “never” or “always”, lecturing, placing blame, etc.). Seventh, affix symbols of useful techniques to be used.

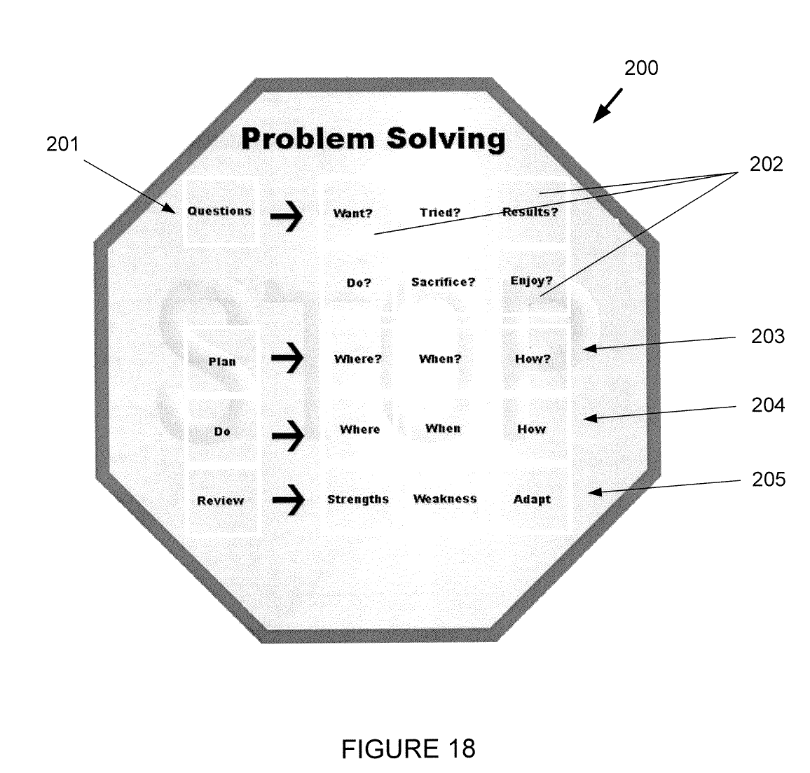

FIG. 18 shows one embodiment of a problem solving chart 200. First, affix symbols in appropriate spaces 202 representing answers to the following questions 201: What do I want? What have I tried? What were the results of my efforts? What am I willing to do to get what I want? What am I willing to sacrifice in order to get what I want? How can I enjoy the process? Second, devise a plan for getting what you want and affix symbols 203 to the chart representing answers to the questions: Where? When? How? For how long? Third, affix symbols 204 representing implementation of your plan (e.g., What will you do? Where? When? How?). Fourth, affix symbols 205 to the chart representing how you will review your plan (e.g., evaluating strengths and weaknesses, adapting the plan to facilitate increasing desirable results).

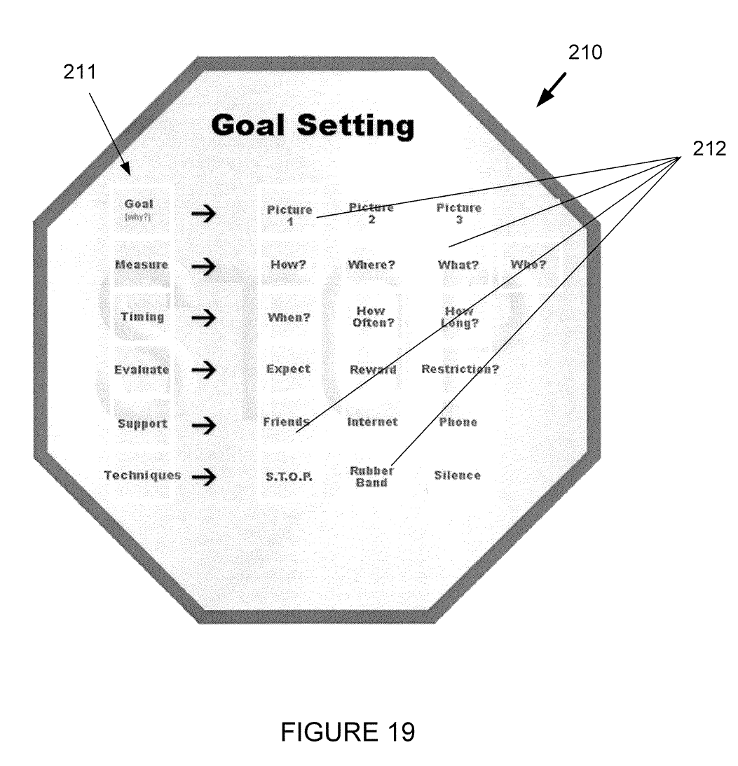

FIG. 19 shows one embodiment of a goal setting chart 210. Along the left side is a list or column 211 of questions or issues to address. First, identify what one wants to accomplish (which should be a realistic goal, e.g., losing weight, decorating a room, learning a sport), and apply appropriate symbols for these to the chart in the appropriate spaces. Second, identify means of measuring progress towards those goals (e.g., how, where, what, who), and apply appropriate symbols for these to the chart in the appropriate spaces. Third, identify the timing of achieving those goals (e.g., when, how often, how long), and apply appropriate symbols for these to the chart in the appropriate spaces. Fourth, identify how progress towards those goals will be evaluated (e.g., minimum expectation, rewards for exceeding that expectation, or restrictions for failing to meet it), and apply appropriate symbols for these to the chart in the appropriate spaces. When evaluating progress, consider whether objectives are helpful or need to be modified to build on strengths or address weaknesses. Fifth, identify how the individual plans to include regular support when working towards the goals (e.g., friends, Internet, telephone, etc.), and apply appropriate symbols for these to the chart in the appropriate spaces. Sixth, identify techniques to assist in accomplishing the goals (e.g., STOP, the rubberband technique, etc.), and apply appropriate symbols for these to the chart in the appropriate spaces.

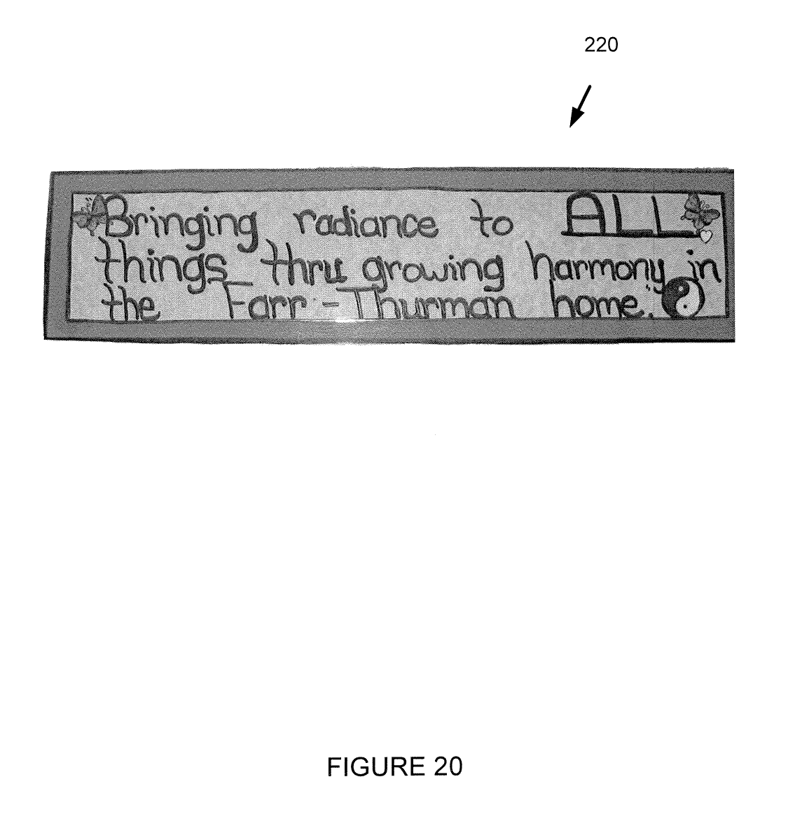

FIG. 20 shows a family intention chart 220 comprising a mission statement that serves as a focal point for the family, clarifying and strengthening family values, beliefs and objectives. The family intention serves as a foundation, and formation of a family intention should involve all family members to the greatest extent possible. The first step in said formation is to write down a brief statement of the family's guiding purpose. The statement should be brief, and in one embodiment should be no more than 25 words. The purpose should be stated positively, in terms of what the family wants to do. The initial writing should be done quickly at first, to foster a narrowing focus on the most desired or cherished values and objectives. This statement can evolve and be refined as needed.

The second step is to summarize this statement on the family intention chart. The family may then select symbols that it feels best embody and express this statement, and affix the symbols to the chart. The chart may then be posted somewhere visible, preferably in a highly trafficked area of the home. The chart may be referred to regularly, with the family members pointing out consistencies or inconsistencies when discussing stories, television, music, decision-making, and the like.

Families with preschool age or school-age children may develop long and short term family and individual goals toward progress and improvement with regard to the family intention. These goals can be worked on in conjunction with the progress pyramid chart. Individuals are rewarded for individual achievements, and family rewards can be received when all members have met the agreed-upon family/group requirements. Family members can be encouraged to document their personal insights and experiences regarding the family intention in a journal, and may share some of these writings at family meeting.

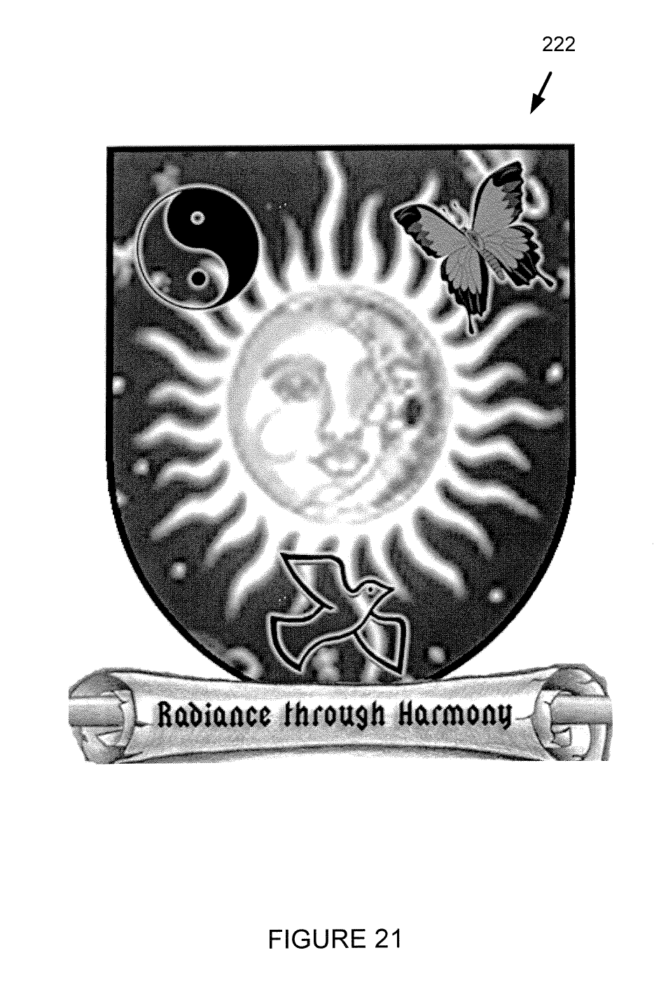

In one exemplary embodiment, some or all of the family intentions or aspirations can be incorporated into a family coat of arms 222. One embodiment of a family coat of arms 222 is shown in FIG. 21.

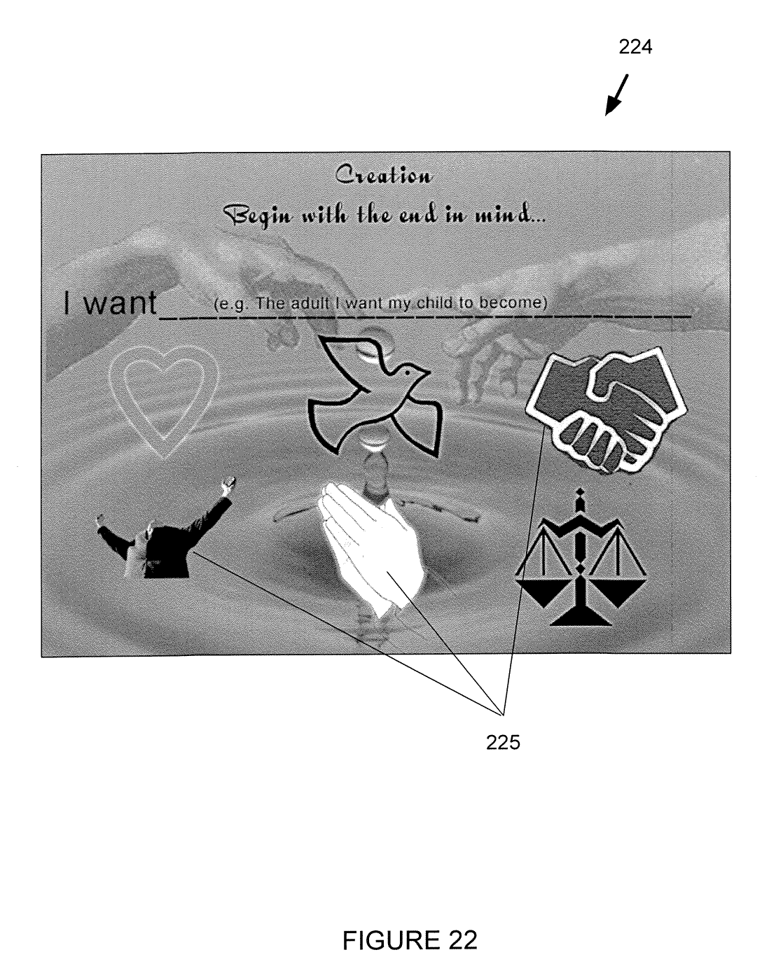

FIGS. 22 shows a vision or manifestation chart 224. The user creates as vivid an image as possible of what is desired. For example, a caregiver may visualize the adult they want their child to grow into. Symbols 225 representing various aspects of that image are chosen and placed on the chart. The chart may be as elaborate as desired, and may be used for a variety of goals or desires, such as job qualities, social networks, relationships, and the like.

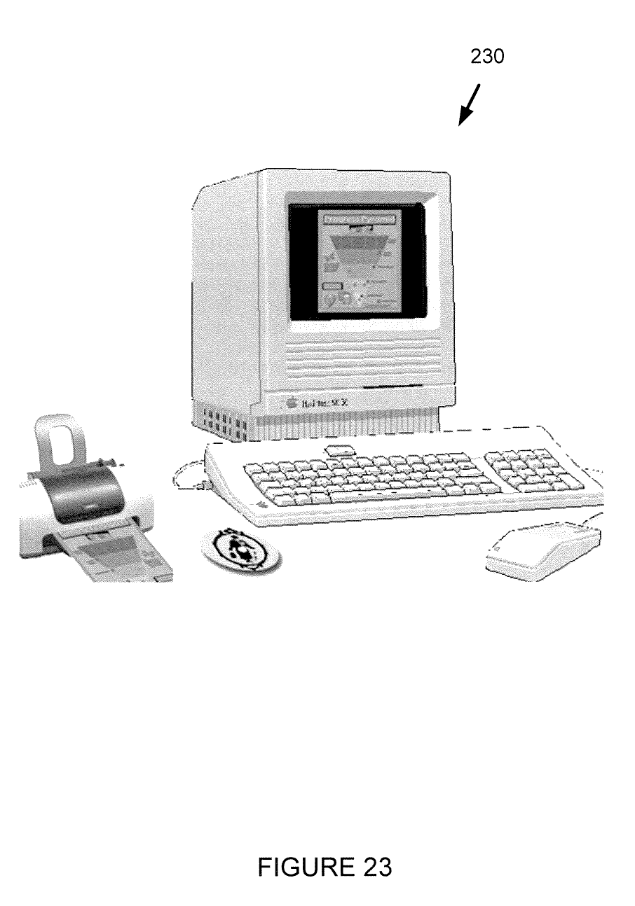

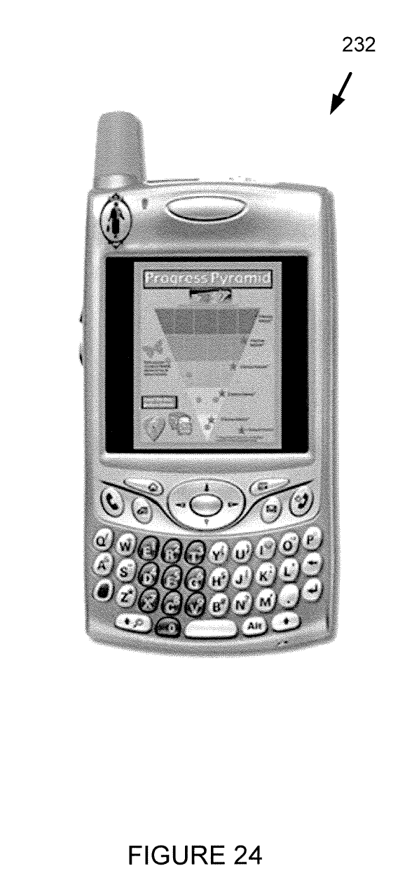

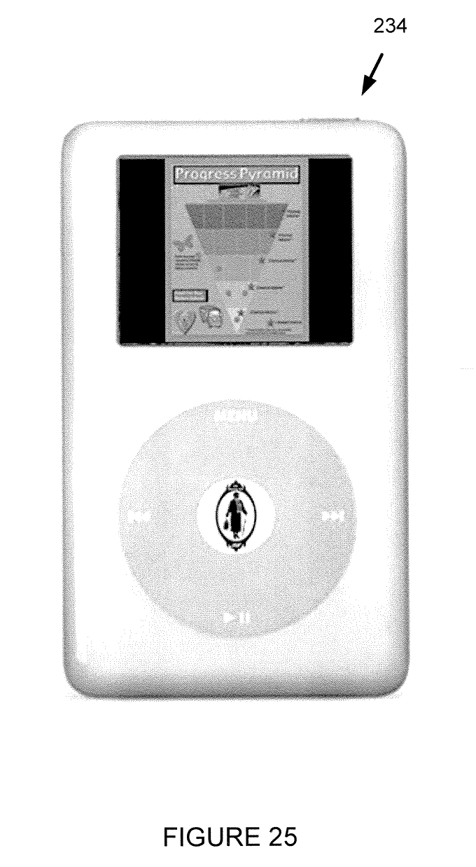

Some or all of the above components (such as, but not limited to, the progress pyramid, work chart, graduated restriction chart, and school success plans) may be formed in a variety of ways. They may be placed on a clipboard or poster, and covered with a material suitable for dry-erase markers, removable stickers, magnetic markers, or the like. In alternative embodiments, these components may be placed in electronic format as a program or graphic image, which may be displayed on a computer screen 230 (see FIG. 23), television, hand-held computer or laptop, a mobile phone or PDA 232 (such as a Treo or Blackberry) (see FIG. 24), a music playing device or an iPod 234 (see FIG. 25), or similar electronic device. The user can interact with the program in the normal manner for said device. Multiple components can reside and be used on each device.

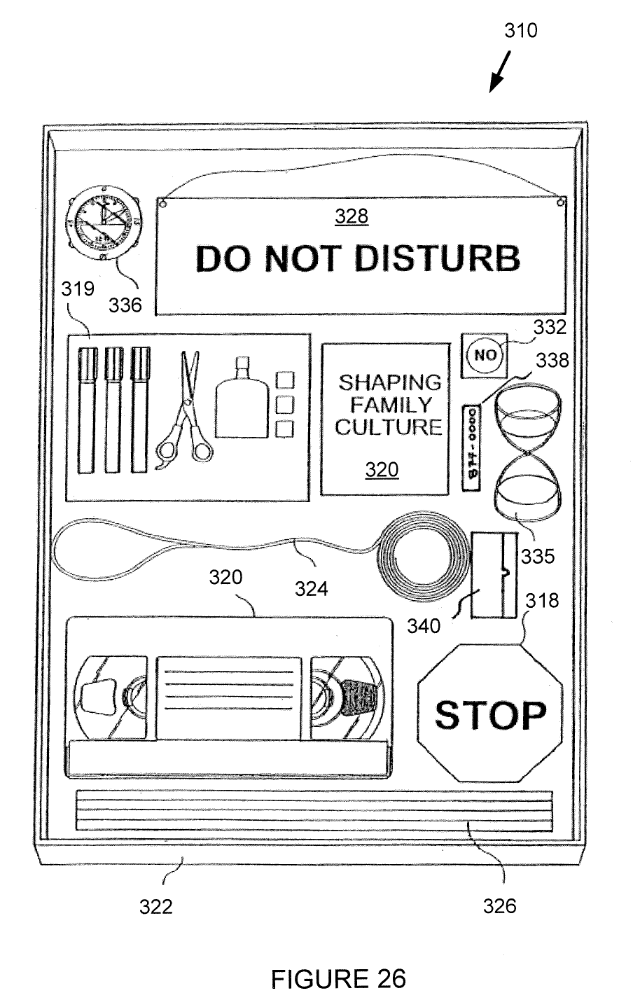

One or more of the components described above can be included with other components in various behavior modification kits. In one exemplary embodiment, a toddler training kit could comprise the elements shown in FIG. 26. In one exemplary embodiment, the kit 310 includes one or more the following components: at least one restraint or time-out defining device 324. 326, at least one timer 312, a communication facilitator 313, a stop sign 318, a plurality of craft tools 319, and a plurality of training devices 320 for a caregiver. The kit also may contain one of more of the charts described above. The kit 310 may include a container 322 for carrying said kit 310. The container 322 may be made of any appropriate material, including but not limited to cardboard or plastic. While the kit 310 and the process for a caregiver to shape the behavior of a child is described herein as applied to a household setting, the kit 310 and process may be modified to apply to various other settings, such as school, daycare, and business settings.

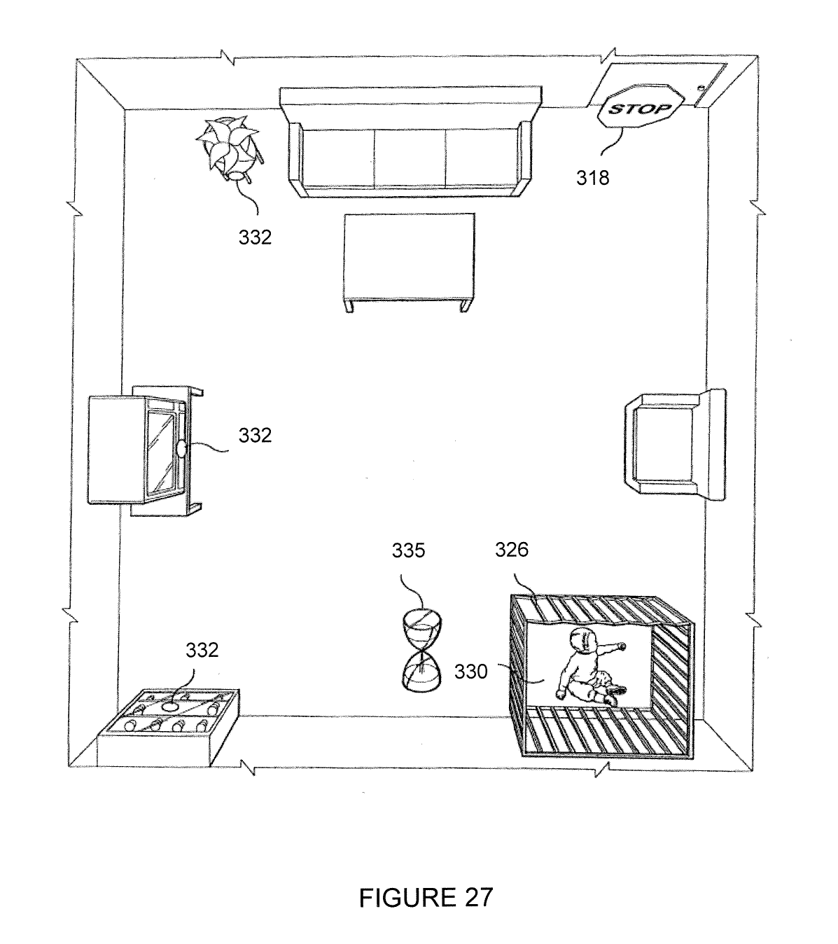

A time-out defining device can include any suitable device which creates a time-out area 330. A time-out area 330 is a specifically defined area in which the child must remain for a limited period of time in response to a misbehavior. Examples of time-out defining devices which may be included in the kit 310 are a leash or tether 324, a collapsible fence 326, or an identifying placard 328 having a phrase such as “do not disturb” or “time-out” printed thereon. The collapsible fence 326 can be any collapsible structure, which when assembled, defines a safe enclosure in which to contain a child, as shown in FIG. 27. A time-out area 330 may also be defined by the area which is accessible to a child once the leash 324 is strapped on to the child. For older children, those who are over three years of age for example, the placard 328 may be used to designate any desired area as a time-out area 330, and the child may be directed to go to the designated area on his or her own. The placard 328 not only identifies the time-out area 330 to the child, but also, alerts others that the child should not be disturbed.

Thus, the time-out area 330 can be defined by the area around which the collapsible fence 326 is erected, any location in a room which is identified by the identifying placard 328, or any other containment area. However, it is preferred that the time-out area 330 not be an area in which the child typically engages in play or recreational activities, such as a bedroom or a playpen, so that the child is not confused as to the purpose of the containment.

Examples of craft tools 319 which may be contained in the kit 310 include markers, glue, magnets, paper, scissors, and blank stickers. The caregiver will utilize the craft 319 tools to create symbols to represent values and goals which the caregiver deems are valuable to the family and affix these symbols to various objects in the house as helpful reminders to the caregiver, the child, and others in the family.

Each stop sign 318 is placed in locations frequented most by both the caregiver and the child. The stop sign 318 will remind children and caregivers alike to stop and think before acting upon a certain impulse.

The caregiver's training devices 320 are to be used by the caregiver for instruction on behavior shaping. Typical examples of caregiver's training devices include, but are not limited to, educational materials, informational materials, video tapes, and a guideline for outlining the family's agreed upon expectations. Also included as part of the caregiver's training devices is a telephone number 338 for the caregiver to call to seek advice from a professional experienced in the area of behavioral science.

In one embodiment of the invention, the caregiver utilizes warning stickers 332 as communication facilitators. The caregiver affixes the warning stickers 332 to items in the house which the caregiver deems are not suitable for the child to contact. The warning stickers 332 have the word “NO” or other prohibitive indicia (such as a “thumbs down”) printed thereon. The warning stickers 332 may also be color coded to indicate which items must not be contacted, and which items require adult supervision or permission to contact.

When a child comes into contact with items having warning stickers 332 or engages in any other misbehavior, a caregiver must immediately restrict the child's movement area. The caregiver may place the child in a time-out area 330, or if the child is not at home, the child's movement may be restricted with a tether or leash 324. For example, if the child is one to three years of age, the caregiver may place the child within the confines of the fence 326 as depicted in FIG. 27. In one embodiment, it is recommended that a child spend one minute in the time-out area 330 for each year of age. After using the kit 310 for about two months, it may be appropriate with some children to increase the time spent in a time-out area 330 by one minute for repetitive misbehavior. Preferably, a child who is one to three years of age should not be confined in excess of five minutes. An automatic timing device (not shown), a sand timer 335, an egg timer 336, or both may be employed to measure the duration the child spends in a time-out area 330. An egg timer 336, for example, allows younger children to monitor how much time has elapsed.

In another form of the invention, designed for children who are three years old and above, the communication facilitator may comprise a contractual instrument 340 to supplement or replace the warning stickers 332. The contractual instrument 340 defines goals and values agreed upon by the child and the caregiver, rewards for achieving goals, as well as misbehavior and restrictions or consequences for misbehavior. The caregiver and the child may utilize the craft tools 319 to create symbols to represent the goals and activities defined in the contractual instrument 340, and affix these symbols to various objects in the house as helpful reminders. When a child misbehaves and/or fails to achieve the stated goals, the child may be placed in a time-out area 330, elect to suffer one of the alternative consequences agreed upon in the contract, or both. An alternative consequence could be, for example, denial of at least one of the child's privileges.

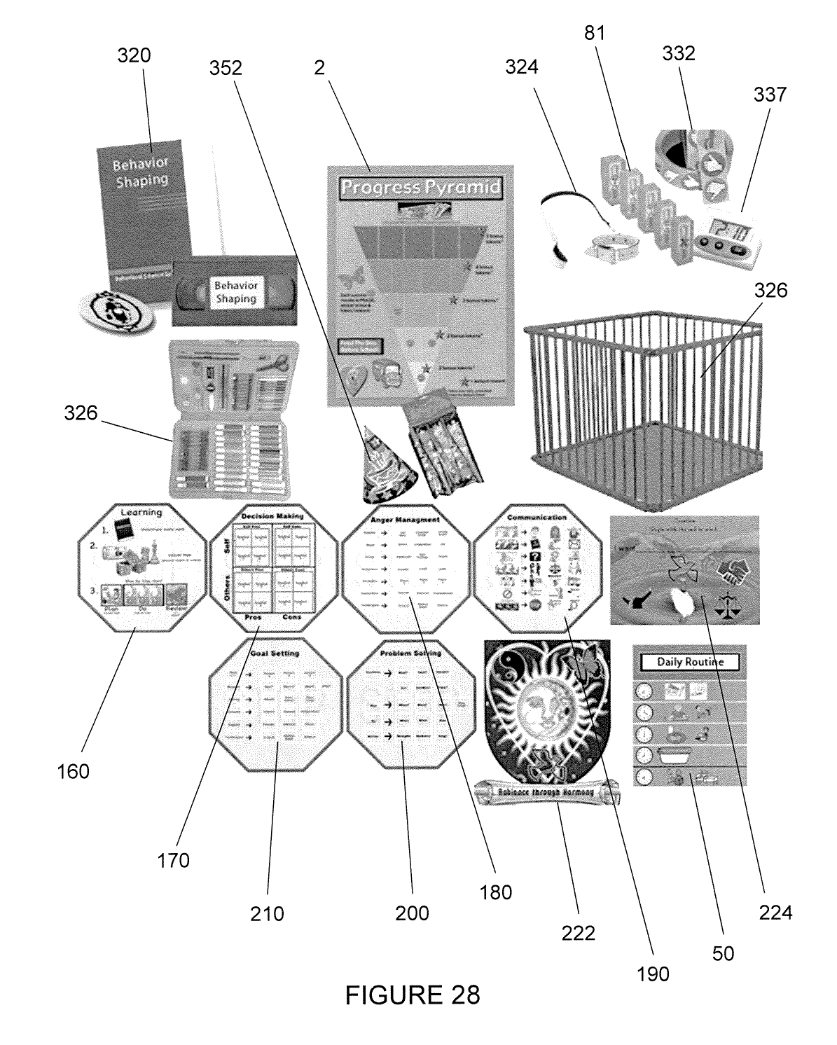

FIG. 28 shows a toddler teaching kit 350 that contains several of the same components as the toddler training kit, but also several new components. In one exemplary embodiment, the toddler teaching kit comprises one or more of the following components: at least one restraint or time-out defining device, such as a tether 324 or collapsible fence 326, at least one timer 312, such as a digital timer 337 or sand glasses 335, a communication facilitator 313, such as warning stickers 332, a plurality of craft tools 319, a plurality of training devices 320 for a caregiver, party favors 352 to celebrate a particular success or event with the child, some form of the above-described progress pyramid chart 2, some form of the daily routine chart 50, and some form of enhanced living skills materials, such as a form of the learning chart 160, decision making chart 170, anger management chart 180, and/or communication chart 190. Other possible enhanced living skills materials include the problem solving chart 200 and goal setting chart 210.

Other forms of kits, as shown in FIGS. 29 and 30, may include a preschool teaching kit, which in one embodiment would include all the elements of the toddler teaching kit as described above, except for the containment or constraining time-out defining device (e.g., leash/tether or collapsible fence). FIGS. 29 and 30 show the placard as a “Do Not Disturb” sign 380. The token system, graduate restrictions chart, and/or work chart could be added. An embodiment of a school-age teaching kit could contain all the elements of the preschool teaching kit plus the school success plan components. The stickers, magnets, or symbols would be appropriate for the age of the child in question. In one embodiment, blank stickers or magnets would be provided so that families can make their own as desired. In addition to being organized into kits or collections, components could be provided or sold separately.

Another form of kit could include family fun day kits, which could include one or more of the following components: painting materials, one or more games, crafting materials or kits, one or more puzzles, camping materials, kites, insect or bug collections or collecting materials, or the like.

It should be noted that in various embodiments of the invention described herein, exceptions to rules may be excused and not penalized when permission is obtained in advance (e.g., a child may be allowed to touch something or move away from their parents when in town, with prior permission).

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art, and variations and changes may be made by those skilled in the art without departing from the spirit of the invention. Accordingly, it is intended that the scope of the invention be defined by the claims appended hereto.

I claim:

1. A system for shaping behavior, comprising:
a primary component for teaching and rewarding progress in learning one or more skills, said primary component comprising a triangle or pyramid with a plurality of individually defined spaces arranged in one or more rows, said rows comprising a first row comprising a single space, with each row thereafter having a greater number of spaces than the preceding row; a plurality of end-spaces, said end-spaces comprising the spaces at one end of each row; and means for marking said individually defined spaces and end-spaces;
wherein each time a child accomplishes the skill or skills being taught, a caregiver marks an individually defined space or end-space in sequence, starting with the first row, proceeding to the next adjacent row in order, and completing each row with the end-space being the final space marked in each row;
further wherein said primary component comprises a token or point system to keep track of a child's progress in learning one or more skills.

2. The system of claim 1, further comprising:
at least one secondary component, said secondary component comprising a chart for tracking daily responsibilities or routines, a chart for addressing problem behavior through graduated restrictions, or a chart for teaching and tracking the performance of certain tasks or work by a particular time.

3. The system of claim 1, further comprising:
at least one life-skills component, said life-skills component comprising a chart to assist in learning, a chart to assist in decision-making, a chart to assist in anger-management, a chart to assist in communications, a chart to assist in problem-solving, or a chart to assist in goal-setting.

4. The system of claim 1, further comprising:
at least one school success component, said school success component comprising a chart for monitoring success in certain school courses on a daily basis, a chart for monitoring success in certain school courses on a weekly basis, or a chart for monitoring success in certain school courses on a monthly basis.

5. The system of claim 1, further comprising:
at least one timer;
a plurality of stickers; and
at least one clip or clothespin.

6. The system of claim 5, wherein there is a plurality of timers, each timer comprising an hourglass of a different color, and further wherein there is a plurality of clips or clothespins in equal number to the plurality of timers, each clip or clothespin of the same color as a corresponding timer.

7. The system of claim 1, further comprising a point-counting or token-counting system wherein a child earns points or tokens based on his or her behavior, accumulates said points or tokens over time, and exchanges said points or tokens for a reward after a period of time.

8. The system of claim 1, further comprising at least one time-out defining device, said time-out defining device comprising a child's leash or tether, a collapsible fence, or a placard having indicia indicating a time-out area.

9. The system of claim 1, further comprising:
a stop sign or a do not disturb sign;
a plurality of craft tools;
means for creating a contractual instrument which defines goals, values, rewards for exceeding expectations, misbehavior, and consequences for misbehavior as agreed upon by both the caregiver and the child; and
a plurality of training devices for the caregiver.

10. The system of claim 1, further comprising means for family members to express gratitude, said means comprising a container wherein family members place slips of paper or other writing material on which the family members have described what they are grateful for.

11. The system of claim 1, further comprising party favors or other means for celebration.

12. The system of claim 2, wherein one or more of said primary and secondary components are displayed and interacted with via electronic means, said electronic means comprising a computer, personal digital assistant, iPod, cellular phone, or handheld computing device.

13. The system of claim 1, further wherein the means for marking comprises stickers, markers, or magnetic devices.

14. The system of claim 1, further wherein the child is rewarded every time a task is accomplished, with an additional reward given each time an end-space is marked.
